(19) United States
(12) Patent Application Publication
(10) Pub. No.: US 2005/0227135 A1
(43) Pub. Date: Oct. 13, 2005

(54) Composite membrane for fuel cell and fuel cells incorporating said membranes

(76) Inventors: Elena Chalkova, State College, PA (US); Mark Fedkin, State College, PA (US); Sridhar Komarneni, Port Matilda, PA (US); Serguei Lvov, Bellefonte, PA (US)

Correspondence Address: Douglas L. Wathen;Gifford, Krass, Groh, Sprinkle,, Anderson & Citkowski, P.C., PO Box 7021, Troy, MI, 48007-7021, US

(21) Appl. No.: 11/104,215

(22) Filed: Apr. 12, 2005

Related U.S. Application Data
(60) Provisional application No. 60/561,356, filed on Apr. 12, 2004.

(51) Int. Cl. H01M 8/10; C08J 5/22

(52) U.S. Cl. 429/33; 521/27

(57) ABSTRACT

A proton exchange membrane is provided which includes a proton exchange polymer, such as Nafion®, and agglomerates of metal oxide or metal phosphate particles. The particles and agglomerates are characterized in specific embodiments in having a high specific surface area. In one configuration an included particle includes a metal oxide or metal phosphate such as SiO₂, ZrO₂, GeO₂, SnO₂, TiO₂ or a zirconium phosphate. A further detailed proton exchange membrane provided according to an embodiment of the invention is a membrane in which one surface is enriched in agglomerates of group IV metal oxide or phosphate particles. Inventive membranes demonstrate improvement in performance under dehydrating conditions compared to unmodified Nafion membranes.

### REFERENCE TO RELATED APPLICATION

This application claims priority of U.S. Provisional Patent Application Ser. No. 60/561,356, filed Apr. 12, 2004, which is incorporated herein by reference in its entirety.

### GOVERNMENT LICENSE RIGHTS

The research carried out in connection with this invention was supported in part by Grant No. DE-FC36-01GO11085 from the DOE and No. DE-AC05-00OR22725 from the DOE/ORNL.

### FIELD OF THE INVENTION

This invention relates generally to fuel cells. More specifically, the invention relates to proton exchange membrane fuel cells (PEMFCs). Most specifically, the invention relates to a membrane for a PEMFC.

### BACKGROUND OF THE INVENTION

Fuel cells are electrochemical devices in which electricity is produced by a chemical reaction between a fuel and an oxidizer. Proton exchange membrane fuel cells (PEMFCs) are a particular type of fuel cell which employs a proton conductive membrane having proton exchange groups thereupon. One such type of polymer is a perfluorosulfonic acid polymer such as the material sold commercially under the trademark Nafion®. PEMFCs are a promising clean energy source for transportation and small scale stationary power generation.

In many instances, it is desirable to operate PEMFCs at elevated temperatures, since this significantly reduces CO poisoning of the catalyst used in the fuel cell and eliminates, or decreases, the need for the use of noble metal catalysts. Also, the reaction kinetics, and hence efficiency of the fuel cell, are increased at elevated temperatures. However, operation of PEMFCs at elevated temperatures can give rise to problems which actually decrease the efficiency of the cells.

High temperature operation of the fuel cells tends to decrease the hydration of prior art proton exchange membrane materials, which in turn decreases their proton conductivity, and hence the efficiency of the fuel cell. Therefore, high temperature operation requires special operational steps and/or device configurations which are necessary to maintain proper hydration of the membranes. In addition, the need for operating prior art membranes at a high relative humidity requires that the gases supplied to the fuel cell be heavily hydrated. In addition to complicating the design of fuel cell systems, this requirement also impacts the composition and hence concentration of the fuel being delivered to the cell thereby decreasing operational efficiency.

In view of the foregoing, it is clear that there is a need for membranes for PEMFCs which have improved qualities compared to previously described membranes. As will be explained in detail herein below, the present invention comprises an improved composite fuel cell membrane.

### SUMMARY OF THE INVENTION

A proton exchange membrane is provided which includes a proton exchange polymer having proton exchange groups thereon and a plurality of agglomerates of metal oxide or metal phosphate particles. The plurality of agglomerates is characterized in that the agglomerates have a size in the range of 100 nanometers to 50 microns along a largest dimension. Optionally, the plurality of agglomerates is interconnected to form a porous network of agglomerates.

In one embodiment a material which includes a metal oxide or metal phosphate has an isoelectric point in the range of pH 0-7 at 25° C.

In general, the metal oxide is selected from the group consisting of: a group IVa metal oxide and a group IVb metal oxide and in a particular embodiment, a metal oxide is selected from among SiO₂, ZrO₂, GeO₂ and SnO₂. In certain embodiments, the metal oxide includes titanium dioxide. In a further embodiment, the metal phosphate includes a zirconium phosphate.

In one embodiment, particles included in an inventive membrane have a zeta potential in the range of 15-55 millivolts at pH 2.5 and at 25° Centigrade and in specific embodiments, the particles have a zeta potential in the range of 35-55 millivolts at pH 2.5 and at 250 Centigrade. Further membranes include particles havinge a zeta potential in the range of −40-−20 millivolts at pH 2.5 and at 25° C.

In one embodiment, a composite membrane is provided in which the proton exchange polymer having proton exchange groups thereon includes a perfluorinated alkene having proton exchange groups thereon such as Nafion®.

A further detailed proton exchange membrane provided according to an embodiment of the invention is a membrane in which one portion of the membrane, preferably one surface of the membrane, is enriched in an inorganic material, particularly including agglomerates of group IV metal oxide or phosphate particles. For example, in a preferred embodiment, more than about 50% of the inorganic material is localized in an inorganic material enriched portion of an inventive membrane. In a further preferred embodiment, about 75-100% of the inorganic material is localized in an inorganic material enriched portion of an inventive membrane

In particular inventive membranes, the plurality of agglomerates are interconnected to form a porous network of agglomerates. In a preferred embodiment, the group IV metal oxide or group IV metal phosphate particles have an isoelectric point in the range of pH 0-7 at 25° C.

Exemplary metal oxide particles included in an inventive membrane include SiO₂, ZrO₂, GeO₂ and/or SnO₂ particles. A preferred metal oxide particle includes TiO₂. A preferred metal phosphate particle includes zirconium phosphate.

Particles included in an inventive membrane have a zeta potential in the range of −100-+100 millivolts at pH 2.5 and at 25° C. Preferred particles have a zeta potential in the range of 15-55 millivolts at pH 2.5 and at 25° C. Further preferred are particles having a zeta potential in the range of 35-55 millivolts at pH 2.5 and at 25° C. Also preferred are particles having a zeta potential in the range of −40-−20 millivolts at pH 2.5 and at 25° C.

In one embodiment, the polymer enriched portion of an inventive membrane is greater in size, and particularly in thickness, than the agglomerate enriched portion. For example, in one embodiment the agglomerate enriched portion is about 0.1-49% of the thickness of the membrane. In another embodiment, the agglomerate enriched portion is about 0.25-30% of the thickness of the membrane. In a preferred embodiment, the agglomerate enriched portion is about 0.5-25% of the thickness of the membrane. In general, the thickness of an inventive membrane is in the range of about 10-300 microns, although one of skill in the art will recognize that an inventive membrane may be thicker or thinnner in specific applications.

Also provided is a membrane electrode assembly including a composite membrane as described herein. Further provided is a fuel cell assembly including a composite membrane as described herein.

Additionally described is a method for producing a composite membrane according to the invention which includes the steps of providing a plurality of metal oxide or metal phosphate particles characterized by a zeta potential in the range of −100-+100 mV at pH 2.5 and at 25° C.; and providing a proton exchange polymer disbursed in a solvent. The particles and polymer are mixed, and the solvent is evaporated producing a composite membrane. Preferred particles have a zeta potential in the range of 15-55 mV at pH 2.5 and at 25° C. In other examples of a provided membrane, particles are included which have a zeta potential in the range of −40-−20 mV at pH 2.5 and at 25° C. Further details of processing are described herein below.

Also detailed is a proton exchange membrane having opposing first and second surfaces and a thickness there between, the membrane including a proton exchange polymer having proton exchange groups thereon and containing an inorganic material localized at the first or second surface of the membrane such that a percentage of the thickness of the membrane ranging between 0.01-50% is enriched in the inorganic material.

A proton exchange membrane is provided which includes a proton exchange polymer; and a plurality of zirconium phosphate particles. In one embodiment, zirconium phosphate particles provided for use in an inventive membrane have layer-structured phases of α-zirconium hydrogen phosphate, α-Zr(HPO₄)₂.H₂O (α-ZPL). In a further embodiment, zirconium phosphate particles provided for use in an inventive membrane have three-dimensional network phases zirconium hydrogen phosphate, H₃OZr₂(PO₄)₃ (ZPTD). In a particular embodiment, zirconium phosphate particles have a specific surface area in the range between 1-200 m²/g, inclusive. In a further embodiment zirconium phosphate particles have a size along a largest dimension in the range between 10 nanometers-1 micron, inclusive. In a specific embodiment, a plurality of zirconium phosphate particles is provided which has a zeta potential in the range of 15-55 millivolts at pH 2.5 and at 250 Centigrade. In a further specific example, a plurality of zirconium phosphate particles is provided which has a zeta potential in the range of −40-−20 millivolts at pH 2.5 and at 25° Centigrade. In one embodiment, zirconium phosphate particles are in the form of agglomerates present in an inventive membrane.

### BRIEF DESCRIPTION OF THE DRAWINGS

FIG. 1 is a graph illustrating performance of a H₂/O₂ PEMFC based on Nafion and Nafion/TiO₂ composite membranes at 80° C., 3 bar, 26 and 100% relative humidity (RH);

FIG. 2 is a graph illustrating performance of a H₂/O₂ PEMFC based on Nafion and Nafion/TiO₂ composite membranes at 120° C., 3 bar, 26, 50, and 100% relative humidity;

FIG. 3 is a graph illustrating the effect of TiO₂ content of the membrane on the PEMFC power density at 0.7 Volts, 120° C. and 3 bar for various relative humidities;

FIG. 4 is a graph illustrating performance of the H₂/O₂ PEMFC based on Nafion and Nafion/TiO₂ composite membranes at 80 and 120° C., 3 bar, and 100% relative humidity;

FIG. 5 is a graph illustrating performance of the H₂/O₂ PEMFC based on Nafion and Nafion/TiO₂ composite membranes at 80 and 120° C., 3 bar, and 50% RH;

FIG. 6 is a graph illustrating a duration test for a recast Nafion/10% TiO₂ membrane;

FIG. 7 is a graph illustrating ohmic resistance of fuel cells employing membranes with various amounts of TiO₂ at different relative humidities at 120° C.;

FIG. 8 is a graph illustrating the Tafel parameter A calculated from voltage (V) vs. current density (i) of a fuel cell employing membranes with various amounts of TiO₂ at different relative humidities, at 120° C.;

FIG. 9A is a digital scanning electron microscopic image of the TiO₂-I (a) powder used for preparing a Nafion/TiO₂ composite membrane;

FIG. 9B is a digital scanning electron microscopic image of the TiO₂-II (b) powder used for preparing a Nafion/TiO₂ composite membrane;

FIG. 10 is a graph illustrating zeta potential, measured at 25° C., as a function of pH of TiO₂ powders, used for preparing particular examples of Nafion/TiO₂ composite membranes;

FIG. 11A is a digital image illustrating SEM-EDS Ti-mapping of the dull side of a Nafion/10% TiO₂ composite membrane prepared using a TiO₂ powder having a specific surface area of 2.9 m²g⁻¹;

FIG. 11B is a digital image illustrating surface morphology of the dull side of a Nafion/10% TiO₂ composite membrane prepared using a TiO₂ powder having a specific surface area of 2.9 m²g⁻¹;

FIG. 11C is a digital image illustrating SEM-EDS Ti-mapping of the shiny side of a Nafion/10% TiO₂ composite membrane prepared using a TiO₂ powder having a specific surface area of 2.9 m²g⁻¹;

FIG. 11D is a digital image illustrating surface morphology of the shiny side of a Nafion/10% TiO₂ composite membrane prepared using a TiO₂ powder having a specific surface area of 2.9 m²g⁻¹;

FIG. 12A is a digital image illustrating SEM-EDS Ti-mapping of the dull side of a Nafion/10% TiO₂ composite membrane prepared using a TiO₂ powder having a specific surface area of 15.5 m²g⁻¹;

FIG. 12B is a digital image illustrating surface morphology of the dull side of a Nafion/10% TiO₂ composite membrane prepared using a TiO₂ powder having a specific surface area of 15.5 m²g⁻¹;

FIG. 12C is a digital image illustrating SEM-EDS Ti-mapping of the shiny side of a Nafion/10% TiO₂ composite membrane prepared using a TiO₂ powder having a specific surface area of 15.5 m²g⁻¹;

FIG. 12D is a digital image illustrating surface morphology of the shiny side of a Nafion/10% TiO₂ composite membrane prepared using a TiO₂ powder having a specific surface area of 15.5 m²g⁻¹;

FIG. 13A is a digital image illustrating surface morphology of a cross section of a Nafion/10% TiO₂ composite membrane prepared using a TiO₂ powder having a specific surface area of 15.5 m²g⁻¹;

FIG. 13B is a digital image illustrating SEM-EDS Ti-mapping of a cross section of a Nafion/10% TiO₂ composite membrane prepared using a TiO₂ powder having a specific surface area of 15.5 m²g⁻¹;

FIG. 14A is a digital image of a scanning electron micrograph showing the dull side of a composite membrane including for Nafion and TiO₂-I at a magnification of 3500;

FIG. 14B is a digital image of a scanning electron micrograph showing the dull side of a composite membrane including for Nafion and TiO₂-II at a magnification of 3500;

FIG. 14C is a digital image illustrating digital image of a scanning electron micrograph showing the dull side of a composite membrane including Nafion and TiO₂-I at a magnification of 10000;

FIG. 14D is a digital image of a scanning electron micrograph showing the dull side of a composite membrane including Nafion and TiO₂-II at a magnification of 10000;

FIG. 15 is a graph illustrating performance of H₂/O₂ PEM fuel cell operated with the recast Nafion and Nafion/10% TiO₂ composite membranes with TiO₂-I powder and TiO₂-II powder at 80° C., 3 bar, and various relative humidities;

FIG. 16 is a graph illustrating performance of H₂/O₂ PEM fuel cell operated with the recast Nafion and Nafion/10% TiO₂ composite membranes with TiO₂-I powder and TiO₂-II powder at 120° C., 3 bar, and various relative humidities;

FIG. 17A is a digital image of a scanning electron micrograph showing layered α-Zr(HPO₄)₂xH₂O;

FIG. 17B is a digital image of a scanning electron micrograph showing three-dimensional network phases H₃OZr₂(PO₄)₃;

FIG. 18 is a graph illustrating performance of H₂O₂ PEMFC based on Nafion and Nafion/zirconium phosphate composite membranes at 80° C., 2 bar, 13% and 50% relative humidity;

FIG. 19 is a graph illustrating performance of H₂/O₂ PEMFC based on Nafion and Nafion/zirconium phosphate composite membranes at 120° C., 2 bar, 13 and 26% relative humidity; and

FIG. 20 is a graph illustrating performance of H₂/O₂ PEMFC based on Nafion and Nafion/zirconium phosphate composite membranes at 120° C., 2 bar, and 50% relative humidity.

### DETAILED DESCRIPTION OF THE INVENTION

The present invention is directed to membranes for fuel cells, and to fuel cells which incorporate those membranes.

The membranes of the present invention are proton exchange membranes, and in that regard they are fabricated from a polymeric material having proton exchange groups thereupon. In a particular embodiment the proton exchange groups are sulfonate and/or carboxylate. In one embodiment, a proton exchange polymer included in an inventive membrane is a perfluorinated alkene having proton exchange groups. In a further embodiment, the proton exchange polymer includes a perfluorosulfonic acid polymer. Also, the proton exchange polymer is a perfluorosulfonic acid/tetrafluoroethylene copolymer in one example of an inventive membrane. Further specific exemplary proton exchange polymers include polysulfones, perfluorocarbonic acid and styrene-divinylbenzene sulfonic acid polymers. In specific embodiments of the invention, the membrane includes a perfluorosulfonic acid polymer, such as Nafion®, as is well known in the art, although it is to be understood that other proton conductive materials may be employed in the practice of the present invention.

The membranes of the present invention further include a proton conducting hygroscopic, inorganic compound dispersed in the polymer comprising the membrane.

The inorganic material of the present invention is a proton conducting material and it is also a hygroscopic material which is capable of retaining water, in the form of a hydrate, an adsorbate, or the like. Some inorganic materials having utility in the present invention are compounds of group IVa and group IVb elements. Some specific examples include compounds of Ti, Zr, Si and Sn. Oxides and phosphates are some materials which may be utilized in the present invention. Some specific examples include SiO₂, ZrO₂, GeO₂ and SnO₂.

In one particular group of embodiments which are described herein, the inorganic material comprises TiO₂.

In a further particular group of embodiments which are described herein, the inorganic material comprises a zirconium phosphate. In one embodiment of an inventive membrane, the inorganic material comprises a zirconium phosphate such as α-Zr(HPO₄)₂. H₂O and/or H₃OZr₂(PO₄).

Inorganic material included in a membrane described herein is a particulate material in one embodiment. Particles are characterized in having particular properties such as size, specific surface area, zeta potential, phase morphology, and isoelectric point.

Generally, particles used in preparing an inventive membrane have a size along a largest dimension in the range between 10 nanometers-10 microns, inclusive. In a particular embodiment, particles used in preparing an inventive membrane have a size along a largest dimension in the range between 0.1-1.0 microns. In a preferred embodiment, such particles have a size along a largest dimension in the range between 0.15-0.4 microns.

In one embodiment, particles used to prepare an inventive membrane are aggregates of smaller particles. Typically, where aggregates are used to prepare a membrane the aggregates have a size along a largest dimension in the range between 0.5-50 microns. In one embodiment, aggregates are used to prepare a membrane, and the aggregates have a size along a largest dimension in the range between 0.75-5 microns. In a further embodiment, aggregates are used to prepare a membrane, the aggregates have a size along a largest dimension in the range between 1-3 microns.

Generally, the particulate material has a very high surface area, and one group of materials employed herein has a surface area in the range of 1-100 m²/g, inclusive, as measured by the BET multipoint N2 surface area analysis technique. A further preferred particle or aggregate has a specific surface area in the range between 1.5-50 m²/g, inclusive. Also preferred is a particle or aggregate having a specific surface area in the range between 2-25 m²/g, inclusive.

Particles or aggregates included in an inventive membrane typically have a zeta potential in the range of −100-100 millivolts at pH 2.5 and at 250 Centigrade.

In one embodiment, particles or aggregates included in an inventive membrane preferably have a zeta potential in the range of 15-55 millivolts at pH 2.5 and at 25° Centigrade. In a further preferred embodiment, the particles or aggregates have a zeta potential in the range of 35-55 millivolts at pH 2.5 and at 25° Centigrade. In another embodiment, the particles or aggregates have a zeta potential in the range of −40-−20 millivolts at pH 2.5 and at 25° Centigrade Further, particles or aggregates included in an inventive membrane preferably have an isoelectric point in the range of pH 0-7, inclusive, at 25° Centigrade. In one embodiment, such particles or aggregates have an isoelectric point in the range of pH 0.1-5, inclusive at 200° Centigrade. Zeta potentials and isoelectric points can be measured and determined at high temperature as exemplified in Zhou, X. Y., et al., Rev. Sci. Instrum., 74:2501-2506, 2003.

In one embodiment, an inventive membrane includes a proton exchange polymer and agglomerates of metal oxide or metal phosphate particles or aggregates. The term “agglomerate” as used herein is intended to mean a body which is essentially a metal oxide or metal phosphate material as described herein. In general, an agglomerate is an association of particles and/or aggregates formed during the process of membrane fabrication. In one embodiment, an inventive membrane includes a plurality of agglomerates having a size in the range of 100 nanometers to 50 microns measured along a largest dimension. In a further embodiment, an inventive membrane includes a plurality of agglomerates having a size in the range of 500 nanometers to 10 microns along a largest dimension.

In one embodiment, at least a portion of agglomerates contained in a membrane are interconnected to form a porous network of agglomerates. Interconnected agglomerates may be connected such that the portion of the agglomerates form a continuous solid. Alternatively, the portion of agglomerates may be connected by contact between separate aggregates.

In a typical application, the inorganic material comprises up to 20% by weight of the membrane. In one embodiment, weight ranges in the amount of 10-20% are generally employed for the practice of the present invention.

In one embodiment, an inventive membrane includes an inorganic material enriched portion and a polymer enriched portion. The term “enriched” as used herein is intended to indicate that a substance is distributed non-homogeneously in a membrane such that more of the substance is located in a first designated portion of the membrane than in a second designated portion. For example, an inorganic material is localized at or near a first surface of an inventive membrane in a preferred embodiment such that more of the inorganic material is localized at or near the first surface than is localized at or near a second surface.

In a further illustration of an inventive membrane, an inorganic material enriched portion is an agglomerate enriched portion which includes a proton exchange polymer and agglomerates of group IV metal oxide or group IV metal phosphate particles wherein more of the agglomerates are present compared to a proton exchange polymer enriched portion including a proton exchange polymer and, optionally, some agglomerates of group IV metal oxide or phosphate particles. For example, in a preferred embodiment, more than 50% of the inorganic material is localized in an inorganic material enriched portion of an inventive membrane. In a further preferred embodiment, 75-100% of the inorganic material is localized in an inorganic material enriched portion of an inventive membrane

In one embodiment, the polymer enriched portion is greater in size than the agglomerate enriched portion. For example, in one embodiment, an agglomerate enriched portion has a thickness of about 0.1-49% of the thickness of the membrane. In a further embodiment, the agglomerate enriched portion extends to about 0.25-30% of the thickness of the membrane. In another embodiment, the agglomerate enriched portion extends to about 0.5-25% of the thickness of the membrane.

A proton exchange membrane is provided in one embodiment which has first and second opposing surfaces, a membrane thickness between the two surfaces, and which includes a proton exchange polymer containing an inorganic material. In a particular embodiment the inorganic material includes agglomerates of a group IVa or group IVb metal oxide or phosphate wherein at least a portion of the agglomerates are localized at the first or second surface of the membrane. In a preferred embodiment, the agglomerate enriched portion is localized to the first surface and not the second surface.

In one embodiment, an inorganic material including agglomerates of a group IVa or group IVb metal oxide or phosphate is localized at a first surface and in a portion of the membrane contiguous to the first surface. In a particular embodiment, the portion of the membrane contiguous to the first surface includes a portion of the thickness of the membrane such that a portion of the thickness of the membrane ranging between 0.1-49% of the total thickness of the membrane is enriched in the inorganic material. Further, in one embodiment, about 75-100% of the total inorganic component included in the membrane is localized at a first surface and a contiguous portion of the membrane, wherein the contiguous portion includes from 0.1-49% of the thickness of the membrane. Preferably, the inorganic component is localized at a first surface and a contiguous portion of the membrane wherein the contiguous portion includes from 0.25-30% of the thickness of the membrane.

In one embodiment, a ratio of an inorganic material as described herein, to proton conducting polymer as described herein, in an inorganic material enriched portion is in the range of 0.05:1.0-20:1. A ratio of an inorganic material to proton conducting polymer in an inorganic material enriched portion may be made by supposing that all the TiO₂ is concentrated in enriched layer, in which case the volume of TiO₂ powder can be calculated from its mass (m) and TiO₂ density (d) as follows: V_{TiO2powder}=m/d. The volume of the whole enriched portion can be calculated as a product of its thickness (h), which can be evaluated from SEM images for instance, and the membrane surface area (S), as follows: V_{TiO2 enriched layer}=h×S. Further, the volume of a proton conducting polymer, such as Nafion, in the inorganic material enriched layer, here shown as TiO₂ as an example, is calculated according to the equation: V_{Nafion}=V_{TiO2 enriched layer}−V_{TiO2 powder}. In addition, the mass of polymer can be calculated as a product of polymer density (D), here denoted Nafion as an example, and its volume as follows: M=D×V_{Nafion}.

In one embodiment, a TiO₂ enriched portion of a membrane including 10% TiO₂-I or 10% TiO₂-II has TiO₂/Nafion ratio of 0.6:1.

In one embodiment, a method for producing a proton exchange membrane includes a recast procedure which includes the step of providing a plurality of metal oxide or metal phosphate particles, providing a proton exchange polymer disbursed in a solvent and mixing the plurality of particles and the polymer. A further step includes evaporating the solvent such that a proton exchange membrane is produced. In a further embodiment, a method for producing a proton exchange membrane includes providing a plurality of metal oxide or metal phosphate particles, the plurality of particles characterized by a zeta potential in the range of −100-+100 mV at pH 2.5 and at 25° C., preferably 15-55 mV at pH 2.5 and at 25° C., providing a proton exchange polymer disbursed in a solvent, mixing the plurality of particles and the polymer; and evaporating the solvent. In another embodiment, the particles are characterized by a zeta potential in the range of −40-−20 mV at pH 2.5 and at 25° C. A preferred metal oxide is selected from the group consisting of: a group IVa metal oxide and a group IVb metal oxide such as SiO₂, ZrO₂, GeO₂ and SnO₂. In a particularly preferred embodiment, an included metal oxide is TiO₂. Also preferred is a membrane in which a metal phosphate is included, particularly a zirconium phosphate. In one embodiment, the proton exchange polymer is a perfluorosulfonic acid polymer, such as Nafion®.

Also provided is a proton exchange membrane which includes a proton exchange polymer; and a plurality of zirconium phosphate particles. Exemplary zirconium phosphate particles provided for use in an inventive membrane have layer-structured phases of α-zirconium hydrogen phosphate, α-Zr(HPO₄)₂.H₂O (α-ZPL), characterized by a zeta potential in the range of −40-−20 mV at pH 2.5 at 25° C.

In a further embodiment, zirconium phosphate particles provided for use in an inventive membrane have three-dimensional network phases zirconium hydrogen phosphate, H₃OZr₂(PO₄)₃ (ZPTD) characterized by a zeta potential in the range of 15-55 mV measured at pH 2.5 and at 25° C., and preferably in the range of 25-35 mV measured at pH 2.5 and at 25° C.

Typically, zirconium phosphate particles have a specific surface area in the range between 1-200 m²/g, inclusive. In one embodiment, zirconium phosphate particles have a size along a largest dimension in the range between 10 nanometers-1 micron, inclusive.

In one embodiment, zirconium phosphate particles, aggregates and/or agglomerates are substantially homogeneously distributed in an inventive membrane. Further, zirconium phosphate particles are optionally in the form of agglomerates present in an inventive membrane.

The membranes of the present invention will have utility in a variety of fuel cell configurations. Hydrogen-oxygen fuel cells are one specific type of cell in which the present invention may be advantageously employed; although it is to be understood that one of skill in the art can utilize this invention in other types of fuel cells, including alcohol and hydrocarbon fueled fuel cells. Also, one of skill in the art can readily adapt the principles of this invention for use in other electrochemical devices.

A fuel cell is provided which incorporates an inventive membrane as described herein. Fuel cell configurations are generally known in the art. A fuel cell typically includes components such as a membrane electrode assembly and hardware. A membrane electrode assembly typically includes such components as an anode, cathode, catalyst and membrane. Hardware components include such structures as backing layers, flow fields and current collectors. Some exemplary fuel cell are described in standard references such as Fuel Cell Technology Handbook, G. Hoogers (Editor), CRC Press, 2002. Also provided is a membrane electrode assembly including an inventive membrane as described herein.

It has been found that membranes of the present invention are capable of operating at high temperature (over 100° C.) and/or low relative humidity (approximately 25%) conditions with an efficiency similar to that of unmodified Nafion® at 80° C. and 100% relative humidity. The membranes maintain high proton conductivity as temperature increases and relative humidity (RH) decreases. Hence, membranes of the present invention may be advantageously incorporated into proton exchange membrane fuel cells configured for operation at high temperature and/or low humidity conditions. Use of the membranes of the present invention permits the efficient operation of these cells.

TiO₂ powders used for preparing composite membranes are characterized in terms of several parameters including phase, morphology, particle size, specific surface area (SSA), zeta potential, and the isoelectric point pHᵢₑₚ (at 25° C.) as shown in Table 1.

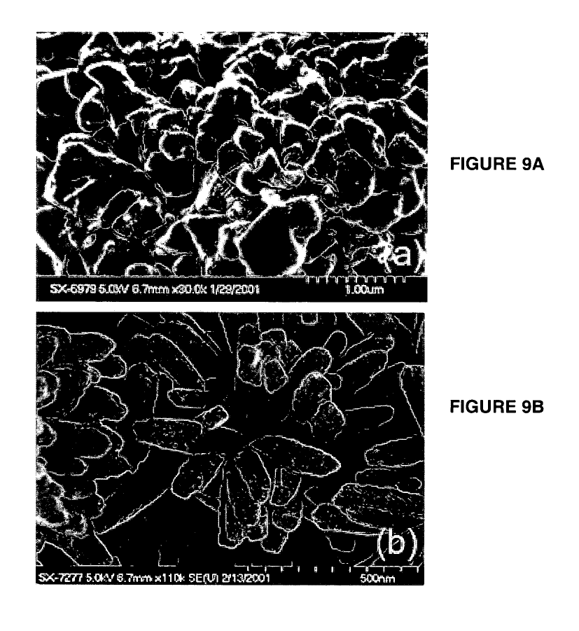

TABLE 1

| | | TiO₂-I | TiO₂-II |
|---|---|---|---|
| Properties | Method | Kronos, Inc. | Tioxide Spec. Ltd. |
| Phase | XRD | Rutile [18] | Rutile [20] |
| Morphology | SEM | Subhedral porous | Aggregates and |
| | | sponge-like | druses of well- |
| | | aggregates of | shaped elongated |
| | | anhedral grains | crystals dominated |
| | | (FIG. 9A) | by (110) face (FIG. |
| | | | 9B) |
| Particle size | SEM | 0.1-1 μm | 0.2-0.3 μm |
| | | | (by elongation) |
| SSA | BET | 2.914 ± 0.004 m² · g⁻¹ | 15.5 ± 1.0 m² · g⁻¹ |
| Zeta potential* | Electro- | +23.2 ± 3.4 mV | +45.5 ± 3.1 mV |
| | phoresis | | |
| pHᵢₑₚ (at 25° C.) | Electro- | 5.26 ± 0.45 [18] | 5.37 ± 0.32 |
| | phoresis | | |

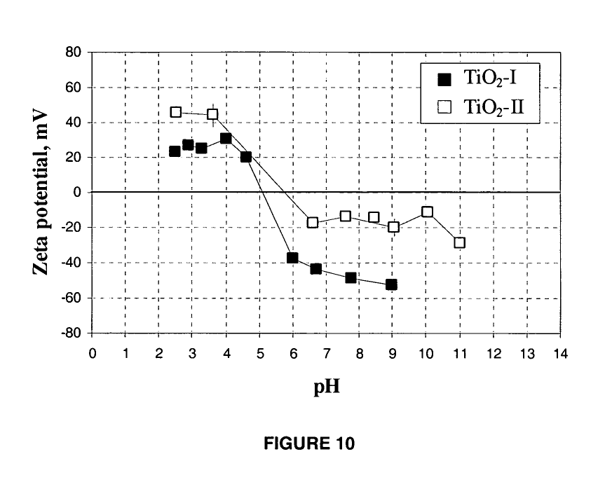

Although two materials (further denoted as TiO2-I and TiO2-II) are represented by the same phase (rutile, α-TiO2) and passed the same pretreatment, there are a few distinctions in their physical properties. First, TiO₂-II, which is represented by smaller particles, has ˜5 times larger SSA compared to TiO₂-I. Second, the morphology of the individual particles and shape of the aggregates are different, as seen in the SEM images (FIGS. 9A and 9B). While TiO₂-I consists of sponge-like porous aggregates of anhedral grains without definite crystal phases, TiO₂-II forms druse-like aggregates of elongated crystals with (110) face domination. Third, the zeta potential of the hydrated surfaces of TiO₂-I and TiO₂-II differs by ˜22 mV at the acidic margin of the pH scale (FIG. 10). The difference in zeta potential may result from the predominance of different faces in their crystal habits.

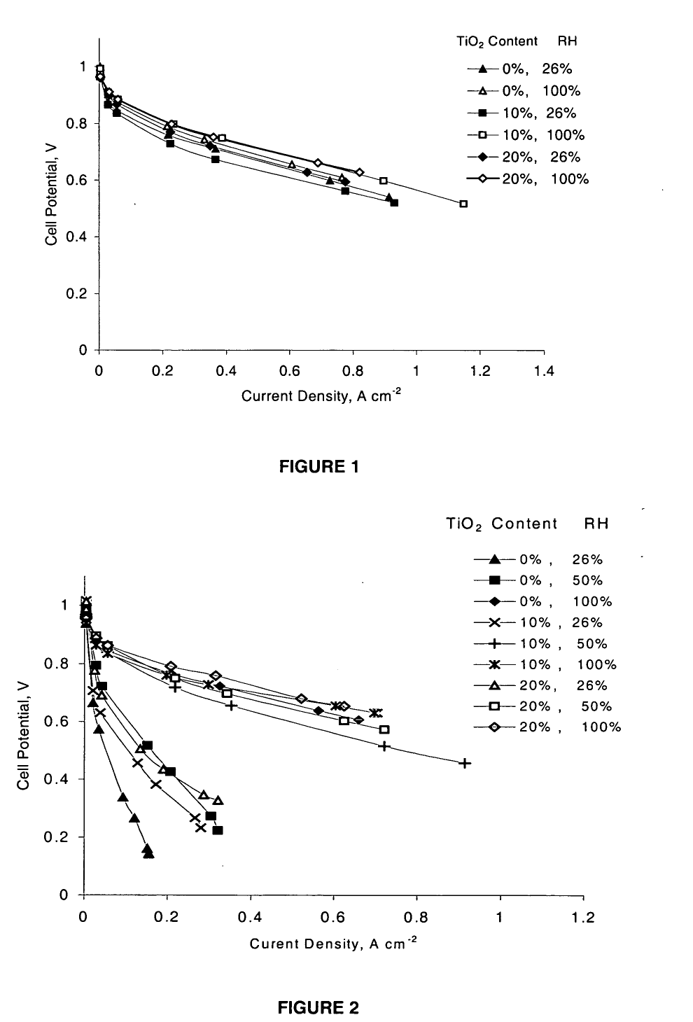

The performance of the H₂/O₂ PEMFCs employing Nafion/TiO₂ composite membranes is evaluated based on cell voltage vs. current density (polarization) curves. The current density is calculated considering the surface area of the gas flow channels. Performance of a H₂/O₂ PEMFC based on Nafion and Nafion/TiO₂-I composite membranes at 80° C., 3 bar, 26 and 100% RH is described and shown in FIG. 1. FIG. 1 shows that when membranes are tested at 80° C., an increase in the TiO₂-I content has no significant effect on the PEMFC performance over the entire range of RH used (from 26 to 100%) The effect of RH on the PEMFC performance is minor but more pronounced for the Nafion/TiO₂-I composite membranes than for the unmodified Nafion membrane.

FIG. 2 shows performance of a H₂/O₂ PEMFC based on Nafion and Nafion/TiO₂-I composite membranes at 120° C., 3 bar, 26, 50, and 100% RH. As seen in FIG. 2, at 120° C., the fuel cell performance is affected by both the TiO₂-I content in membranes and RH. The effect of the TiO₂-I content on PEMFC performance is greater at reduced relative humidity. When the TiO₂-I content increased from 0 to 20%, the current density delivered at cell voltage of 0.6 V, is increased, respectively, by 3, 5.8, 1.6, and 1.1 times at 26, 50, 80 (data at 80% RH not shown in FIG. 2), and 100% RH. The effect of RH (ranging from 26 to 100%) is significant for the unmodified Nafion membrane. The performance of the Nafion/TiO₂-I composite membranes is more RH-sensitive at reduced RH values.

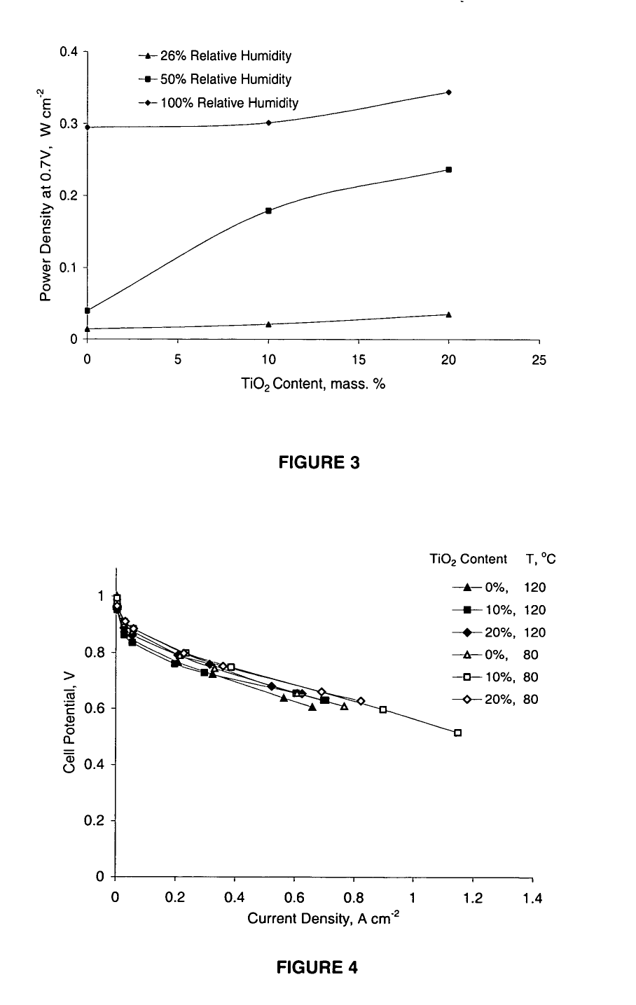

FIG. 3 shows the effect of the TiO₂-I content of the membrane on the PEMFC power density at 0.7 Volts, 120° C. and 3 bar for various RHs.

Hydrophilic TiO₂ improves the water retention properties of the membranes and, therefore, their hydration, which in turn favors the Nafion proton conductivity and fuel cell performance. Improvement of membrane humidification in the presence of TiO₂ is more evident at reduced RH because, in this case, the initial water uptake of the membranes is small, and the fraction of water associated with the solid oxide particles is significantly higher than that in the case of well hydrated membranes. Water retention by TiO₂ substantially changes the level of membrane hydration and, consequently, its conductivity and the performance of PEMFCs. At a high relative humidity, when Nafion contains enough water to effectively conduct protons, addition of moisture to the membranes does not substantially change the membrane hydration and conductivity.

The performance of the PEMFC is also influenced by the decrease in partial pressures of the reactant gases in the feed fuel stream at operating conditions. In fact, when the fuel cell is operated at 120° C. and total pressure of 3 bar, the increase of RH from 26 to 100% lowered the partial pressures of the reactant gases by the order of 2.5, which negatively affects the performance of the fuel cell. However, as shown in FIG. 2, this effect is much smaller than the effect of membrane hydration, performance of the membranes substantially increased with increasing RH. When the fuel cell is operated at 80° C., the decrease in H₂ and O₂ partial pressures due to RH increase is relatively small. Dehydration of the membranes at this temperature is also insignificant; thus, the RH and addition of hydrophilic inorganic material to the membrane material is not expected to significantly affect the fuel cell performance.

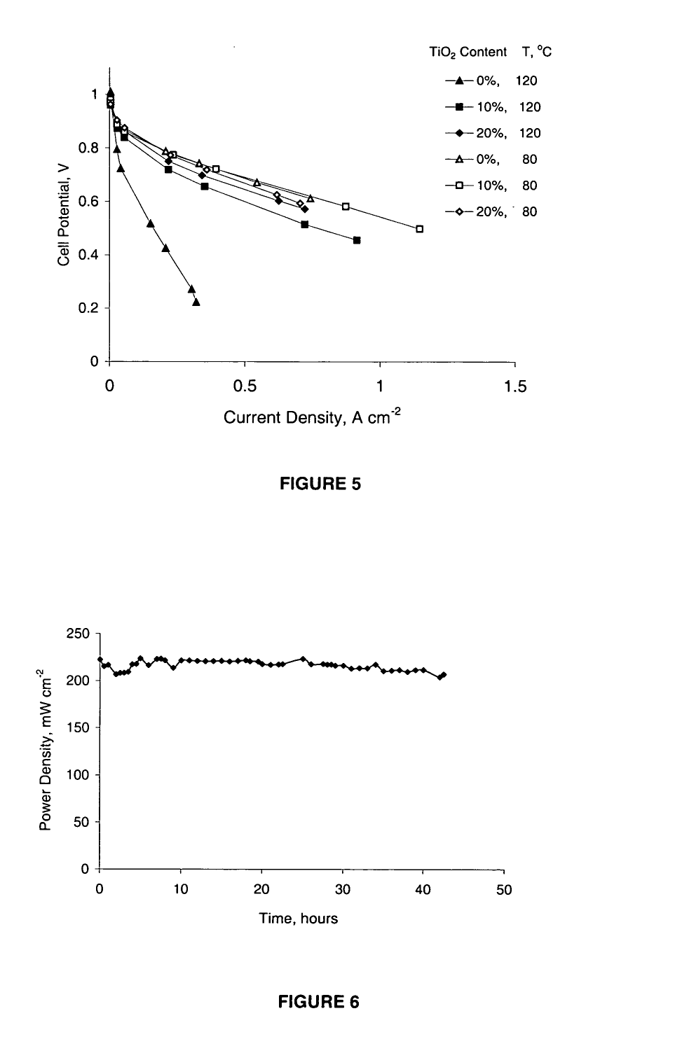

FIG. 4 illustrates performance of the H₂/O₂ PEMFC based on Nafion and Nafion/TiO₂-I composite membranes at 80 and 120° C., 3 bar, and 100% RH and FIG. 5 shows performance of the H₂/O₂ PEMFC based on Nafion and Nafion/TiO₂-I composite membranes at 80 and 120° C., 3 bar, and 50% RH. In general, PEMFC performance at 80° C. is higher than that at 120° C. When the temperature is increased from 80 to 120° C., the performance declines much more significantly at reduced RH and for unmodified Nafion membranes as seen in FIGS. 4 and 5. For the fully hydrated membranes, the performance decrease may be due to the decreased partial pressures of the reactant gases in the feed, related to increasing the humidifying temperature. When a PEMFC is tested at 100% RH and constant hydrogen and oxygen partial pressures, the performance is higher at 120° C. than at 80° C. At 50% RH, the magnitude of gas partial pressure reduction with increasing temperature is much smaller and the decrease in fuel cell performance is mainly due to membrane dehydration at 120° C. In this case, the composite membranes show a significant advantage over unmodified Nafion membranes, demonstrating that hydrophilic TiO₂ provides better water retention than bare Nafion polymer at a reduced RH. Performance of the composite Nafion/20% TiO₂-I membrane at 120° C. and 50% RH is comparable to the performance of the unmodified Nafion membranes at 80° C. and 100% RH. A composite membrane that contains 20 mass % of TiO₂ allows increasing the operating temperature of the PEMFC from 80 to 120° C. at a reduced (50%) RH without any significant performance loss.

FIG. 6 illustrates results of a membrane stability test conducted with the Nafion/10% TiO₂-I composite membrane at 120° C. and 50% RH. The fuel cell power level is found to be relatively stable with a total decline of about 7% for 45 hours. Performance of the recast Nafion membrane at the same operating conditions sharply declined after 25 hours of operation.

The benefits of having inorganic particles in the fuel cell membrane can be related to both water retention and proton conductivity. The water retention increases due to the adsorption of the aqueous species H⁺ and OH⁻ in the electric double layer (EDL) of the solid particles. The adsorbed species in the EDL are under an electrical field, which provides the force retaining water at the surface. When the temperature is increased above 100° C., the water incorporated into the EDL of solid oxide particles does not evaporate as easily as does the “free” water in the Nafion polymer. The ability of a particular solid oxide to retain water depends on the strength of the electrostatic attraction within the EDL. The primary indicator of this attractive force is the zeta potential at the solid oxide/water interface. In most cases, a higher magnitude of the zeta potential implies a higher proton charge and, therefore, a higher concentration of water species adsorbed (retained) at the solid oxide surface. The zeta potential is the surface potential measured at the shear plane, which is located at a hypothetical distance Dₛ from the surface and divides the hydrodynamically immobile and mobile parts of the EDL. Therefore, the experimental data on zeta potential at the solid oxide/water interface can be used to estimate the Dₛ parameter and to determine the geometric thickness of the part of the EDL that is strongly attached to the particle surface.

As a result of zeta potential data fitting using the temperature compensated MUSIC model combined with the basic Stern representation of the EDL, see M. V. Fedkin, X. Y. Zhou, J. D. Kubicki, A. V. Bandura, S. N. Lvov, M. L. Machesky, and D. J. Wesolowski, Langmuir, 19, 3797 (2003); and see M. L. Machesky, D. J. Wesolowski, D. A. Palmer, and M. K. Ridley, J. Colloid Interface Sci., 239, 314 (2001), the shear plane positions (Dₛ) of rutile particles are determined at 3.5 and 6.1 nm from the head of the diffuse layer at the ionic strengths of 0.01 and 0.001 mol·kg⁻¹, respectively. The Dₛ parameter is found to be primarily a function of ionic strength, while its variation with temperature is within the range of experimental error. Based on these values, the volume of hydrodynamically immobile water retained by the EDL can be estimated as:

$${V}_{{H}_{2} O}^{EDL} = SA \times {D}_{s} \qquad [ 6 ]$$

where SA is the specific surface area of the TiO₂ powder used (2.914 m²·g⁻¹). This estimation involves the assumption that the compact (Stern) part of the EDL is very thin and its contribution to the EDL volume is negligible. With Dₛ=6.1 nm, Eq. [6] yields the volume of 0.0018 cm³ of adsorbed water per gram of TiO₂ powder. This value is only 0.8% of the maximum total water uptake determined for the fully hydrated Nafion/20%-TiO₂ composite membrane. Therefore, if the membrane is at 100% RH, the presence of the solid oxide phase would not bring significant benefits to membrane hydration. This suggestion is confirmed by the experimental data at RH 100% (FIG. 2, open symbols), when the fuel cell performance curves for the composite membranes and unmodified Nafion are almost identical. However, at a reduced relative humidity, the advantage of the composite membranes is obvious (FIG. 2, filled symbols), which means that the fraction of water associated with solid oxide particles should be significantly higher than in the case of complete hydration. While the TiO₂ microparticles are able to enhance water retention of membranes, the maximum water uptake of the fully hydrated composite membranes is not significantly higher than that of unmodified Nafion membranes. Due to this observation and also the large size of the TiO₂ particles (up to 5-10 micron for the TiO₂I powder), we do not assume any changes in the Nafion nanostructure. The composite is rather considered to be a physical mixture of Nafion and TiO₂.

While the water in the compact part of the EDL is not believed to make a significant input to membrane hydration, the weakly bound water in the membrane can also be affected by the electric field at the contact between Nafion and TiO₂. Under acidic conditions, the surface of TiO₂ has a high positive charge, whereas the surface of Nafion is negatively charged due to dissociation of sulfo-groups (—SO₃H). Thus, water molecules located between these two surfaces should be influenced by an electric field. While the charged solid oxide surface acts as a water retainer, this water can easily diffuse into Nafion and participate in ion transport.

The cell potential (V) vs. current density (i) behavior at different temperatures, RHs, and TiO₂ content in the membranes is analyzed by fitting this data to the following equation:
V=Vᵣ−A ln(i/iₒ)−Ri [7]
where Vᵣ is the reversible cell potential (calculated using the Nernst equation), A and iₒ are Tafel parameters, and R is the resistance, which causes a linear variation of V with I, see J. Larnie, A. Dicks, Fuel Cell Systems Explained, J. Wiley & Sons. Ltd., Artrium, Southern Gate, Chichester, West Sussex, England (2003).

A nonlinear parameter estimation code included in the SigmaPlot© software, is used to determine the parameters A, iₒ, and R. Equation (7) is modified and presented as
V=Vₒ−A ln i−Ri, [8]
where Vₒ is defined as
Vₒ=Vᵣ+A ln iₒ [9]

At first, all cell potential (V) vs. current density (i) data are fitted to Eq. [8], and the parameters Vₒ, A, and R are derived from this equation. The calculation yielded the values of these parameters with correlation coefficients in excess of 0.995 and small standard deviation. Then, the parameter iₒ is calculated from Eq. [9]. The values of the reversible potential (Vᵣ) at 80 and 120° C. and different RH values are calculated from the Nernst equation, assuming that the steam behaves as an ideal gas.

The electrochemical kinetic parameters derived from Eqs. [8] and [9] are presented in Table 2.

TABLE 2
Electrochemical kinetic parameters for a PEMFC employing Nafion/TiO₂ composite membranes.

| | Relative Humidity, % | | | | | | | | | | | |
|---|---|---|---|---|---|---|---|---|---|---|---|---|
| | 26 | | | | 50 | | | | 100 | | | |
| TiO₂ | R | Vᵣ | A | Iₒ | R | Vᵣ | A | Iₒ | R | Vᵣ | A | Iₒ |
| Cont., % | (Ω cm²) | (V) | (V) | (A cm⁻²) | (Ω cm²) | (V) | (V) | (A cm⁻²) | (Ω cm²) | (V) | (V) | (A cm⁻²) |

120° C.

| | | | | | | | | | | | | |
|---|---|---|---|---|---|---|---|---|---|---|---|---|
| 0 | 1.71 | 1.207 | 0.145 | 6.6 × 10⁻⁴ | 1.19 | 1.189 | 0.082 | 3.4 × 10⁻⁴ | 0.22 | 1.160 | 0.043 | 6.2 × 10⁻⁵ |
| 10 | 0.48 | 1.207 | 0.137 | 7.0 × 10⁻⁴ | 0.30 | 1.189 | 0.043 | 2.1 × 10⁻⁵ | 0.15 | 1.160 | 0.042 | 3.0 × 10⁻⁵ |
| 20 | 0.48 | 1.207 | 0.117 | 6.1 × 10⁻⁴ | 0.29 | 1.189 | 0.036 | 6.4 × 10⁻⁶ | 0.25 | 1.160 | 0.028 | 2.1 × 10⁻⁶ |

80° C.

| | | | | | | | | | | | | |
|---|---|---|---|---|---|---|---|---|---|---|---|---|
| 0 | 0.22 | 1.225 | 0.040 | 6.1 × 10⁻⁶ | 0.23 | 1.214 | 0.037 | 6.3 × 10⁻⁶ | 0.24 | 1.201 | 0.037 | 1.1 × 10⁻⁵ |
| 10 | 0.26 | 1.225 | 0.046 | 1.4 × 10⁻⁵ | 0.23 | 1.214 | 0.033 | 2.5 × 10⁻⁶ | 0.26 | 1.201 | 0.032 | 3.4 × 10⁻⁶ |
| 20 | 0.26 | 1.225 | 0.032 | 9.8 × 10⁻⁷ | 0.32 | 1.214 | 0.027 | 3.8 × 10⁻⁷ | 0.25 | 1.201 | 0.026 | 3.9 × 10⁻⁷ |

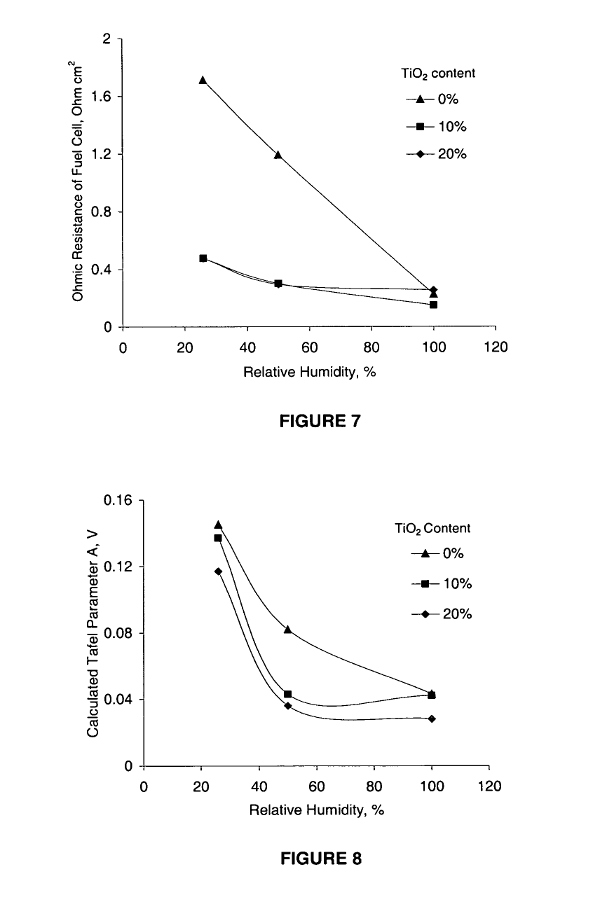

As can be seen from Table 2, the parameter R, that predominantly represents the ohmic resistance of the membrane, is not affected by TiO₂-I content in membranes and RH at the temperature of 80° C., but their effect is clearly pronounced at 120° C. (FIG. 7). When RH decreased, the increase in resistance is significantly higher for unmodified Nafion membranes than for Nafion/TiO₂-I composite membranes.

In addition to a change in the resistance of the membranes, the Tafel slope A decreases with the increase of TiO₂-I content in membranes and RH very slightly at 80° C., and significantly at 120° C. (FIG. 8). Thus, the increase of RH in the cell, and the contact of the electrodes with hydrated TiO₂ particles also improves the hydration of the ion conducting phase in the electrode (Nafion), which positively affects the electrochemical kinetics of the electrodes. The obtained parameter iₒ shows an increase with the temperature and a decrease with the TiO₂ content and RH. This parameter, as calculated from Eq. [7], is not the real exchange current density, but rather represents a combination of the exchange current density and the internal current density, which occurs due to membrane gas permeability. The internal current density increases with increasing TiO₂ content and increasing RH. In addition, the increase of RH at operating conditions (total pressure of 3 bar), leads to the reduction of gas partial pressure and, consequently, iₒ.

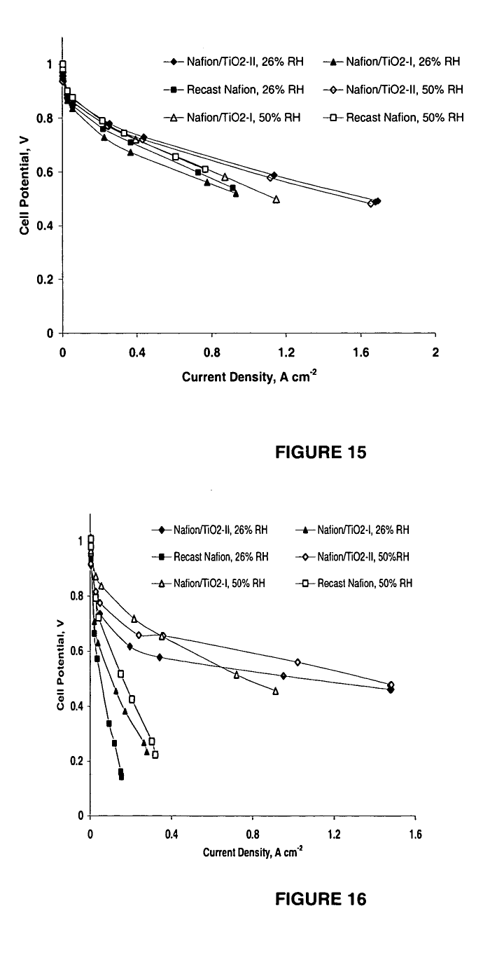

At 80° C., the composite membranes containing higher-SSA TiO₂-II (15.5 m²g⁻¹) exhibit an increase in performance compared to the membranes containing lower-SSA TiO₂-I (2.9 m²g⁻¹) over the entire RH range used (from 26 to 50%) (FIG. 15). This effect is particularly pronounced at low RH (26%). Thus, the current density delivered at a cell voltage of 0.6 V increased by the order of 1.7 and 1.2 at 26% and 50% RH, respectively, for the Nafion/TiO₂-II membrane compared to the Nafion/TiO₂-I membrane. The performance of the Nafion/TiO₂-I composite membranes is comparable with that of the recast Nafion membranes with no added TiO₂ at both RH values. It should also be noted that the Nafion/TiO₂-I membranes performance is quite sensitive to RH variation, while the performance of the Nafion/TiO₂-II membranes is almost the same over the entire RH range used (FIG. 15).

At 120° C., the performance of the Nafion/TiO₂-I composite membranes is substantially higher than that of the recast pure Nafion membranes at both RH values, especially at RH of 50%. The difference in performance between the Nafion/TiO₂-I and Nafion/TiO₂-II membranes is even larger than that at 80° C., particularly at low RH levels (26%) (FIG. 16). Thus, the current density obtained at cell voltage of 0.6 V for the Nafion/TiO₂-II membrane was 4 and 1.4 times higher at 26 and 50% RH, respectively, compared to that for the Nafion/TiO₂-I membrane. However, the performance of the composite membranes containing higher-SSA TiO₂-II is much less affected by a decrease in RH.

The Nafion/TiO₂-II composite membranes demonstrate much higher limiting current than Nafion/TiO₂-I membranes at 80° C. and especially at 120° C. (FIGS. 15 and 16). The limiting current density obtained at 80° C. increased by 1.8 and 1.4 times at 26% and 50% RH, respectively. The limiting current density obtained at 120° C. increased by 6.4, and 1.6 times at 26%, and 50% RH, respectively. These results suggest that some TiO₂ surface properties, such as the surface area, morphology, and surface electrical double layer in composite membranes facilitate the flow of protons through conduction paths and decrease the membrane resistance. Also, these results demonstrate that the combination of the surface properties of TiO₂-II provides a mechanism that affects the overall membrane resistance perhaps due to better water retention and/or enhanced flow of protons through conduction paths or both of these factors. It is that the limiting current density may be affected by positioning the layered membrane with respect to the cathode and anode.

When the total percentage of TiO₂ component is kept the same, the number of proton adsorption sites associated with TiO₂ surface increases proportionally with increasing SSA, and this is further enhanced by the higher apparent proton-induced surface charge density, i.e., higher zeta potential at the low pH limit, of the TiO₂-II material. As a result, the amount of interfacial water molecules is substantially increased, and the PEM fuel cell performance obtained using the membrane with larger-SSA TiO₂ is higher (FIG. 16). The performance improvement due to the increased SSA of TiO₂ is more evident at reduced RH's because, in this case, the initial water uptake of the membranes is small, and the fraction of water associated with the additional hydrophilic sites at the TiO₂ surface was significantly higher than that in the case of well-hydrated membranes.

A difference in zeta potential between inorganic materials may be related to morphological distinctions. The zeta potential is closely correlated with the surface protonation charge and, therefore, depends on the type and density of the surface protonation sites on the particle surface. The Multisite Complexation (MUSIC) model calculations for the TiO₂/water interface (see Ticianelli, C. R. Derouin, A. Redondo, and S. Srinivasan, J. Electrochem. Soc. 135, 2209 (1998) imply that individual crystal faces may have different zeta potentials and isoelectric points due to the different surface structure, while the measured values for powders and polycrystalline aggregates would rather represent the average zeta potential value of a large number of individual faces. The powder TiO₂-I is mainly anhedral without well-defined faces, while the powder TiO₂-II is much better crystallized and dominated by the (110) face. Thus, the different average zeta potentials in the low-pH limit measured by the electrophoresis technique for these powders at pH 2-3 (FIG. 10) may reflect the different contributions of specific crystal faces to the net value. With respect to the fuel cell membranes, a TiO₂ material having a higher average zeta potential is preferred since as having a more electrically active surface, which adsorbs a greater number of protons per unit surface area (as well as per unit mass of powder) and therefore is able to bind more water molecules.

As described above, water can be efficiently retained at the TiO₂/water/polymer interfaces due to not only adsorptive bonds, but also the electrostatic field between the positively charged TiO₂ surface and negatively charged sulfonate sites along the Nafion polymer chains. Thus, the free water molecules beyond the electrical double layer of TiO₂ are also affected. An inorganic surface with higher zeta potential is able to create a stronger electric field and, therefore, may provide higher water retention in the TiO2/water/polymer interfaces. Further, a powder with higher zeta potential and proton surface charge may be a more efficient proton conductor due to higher surface concentration of charge carriers providing an additional proton conductivity path through the protonated layer at the TiO2/water interface.

In a further embodiment, composite membranes are fabricated using two crystalline zirconium phosphates (α-ZPL and ZPTD) and an amorphous one (in situ ZP) with different surface properties (specific surface area, particle morphology). Two exemplary methods are used to incorporate an inorganic component, such as zirconium phosphate in a membrane: 1) the dispersion of inorganic powders in a polymer solution, followed by a casting procedure and 2) in situ formation of zirconium phosphate (ZP) particles in a recast polymer membrane by ion exchange. Membranes are used in a H₂/O₂ PEM fuel cell over a range of RH from 13 to 50% at temperatures of 80 and 120° C.

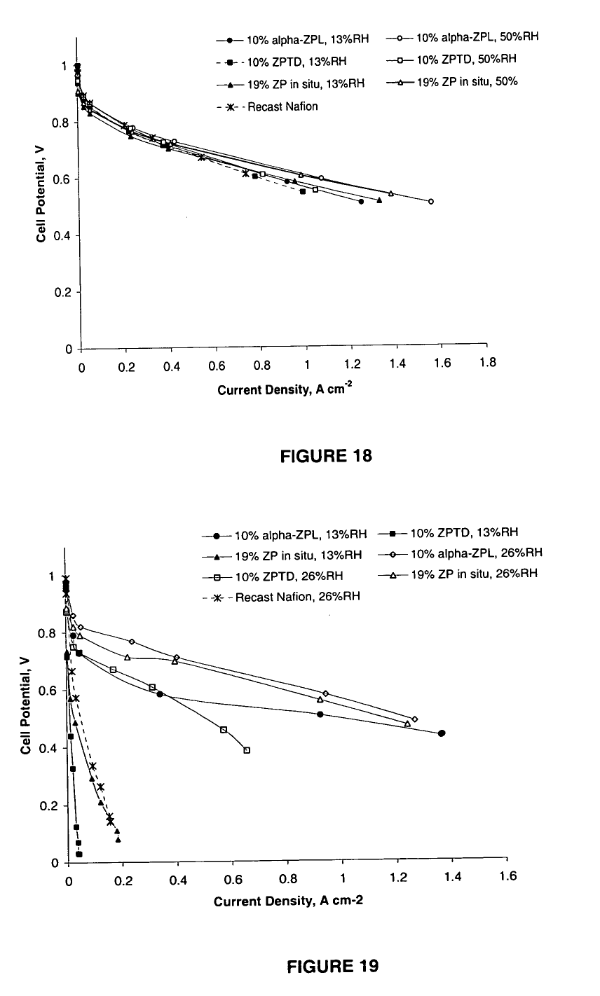

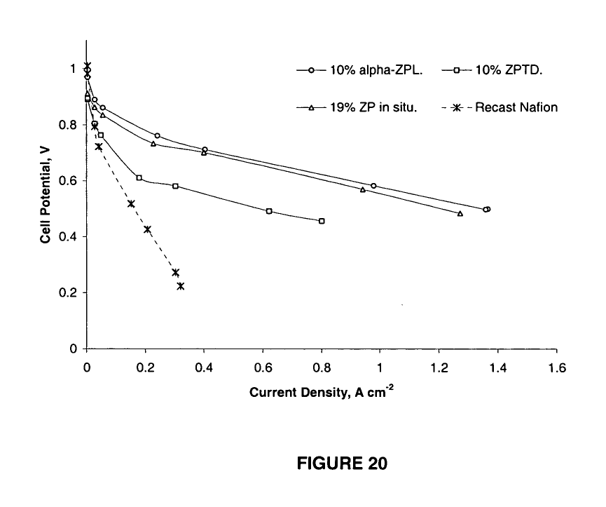

When the membranes are tested at 80° C., the structure of zirconium phosphate has no significant effect on the PEMFC performance over the entire range of RH used, from 13 to 50%. (FIG. 18). The performance of the composite membranes with α-ZPL and ZP in situ is very close at all RH used, and the composite membranes containing ZPTD exhibit slightly lower performance than membranes containing α-ZPL and zirconium phosphate in situ.

At 120° C., membranes tested demonstrate significant improvement in performance under dehydrating conditions compared to unmodified Nafion membranes (FIG. 19, 20). The difference in the performance of Nafion/zirconium phosphates membranes containing zirconium phosphates of different structure is much larger at 120° C. than that at 80° C., particularly at the lowest RH level of 13% (FIG. 19). The Nafion/α-ZPL composite membrane demonstrates the highest performance at all RH values. A distinction between the performance of this membrane and two others is especially pronounced at 13% RH; while the performance of both Nafion/ZPTD and Nafion/ZP in situ membranes is slight, the performance of Nafion/α-ZPL is quite high. Thus, the current density obtained at a cell voltage of 0.6 V for the Nafion/α-ZPL at 13% RH is ten times higher than that of an unmodified recast Nafion membrane at 26% RH. At 26 and 50% RH the performance of Nafion/α-ZPL and Nafion/ZP in situ membranes is close while the performance of Nafion/ZPTD is significantly lower (FIG. 19, 20).

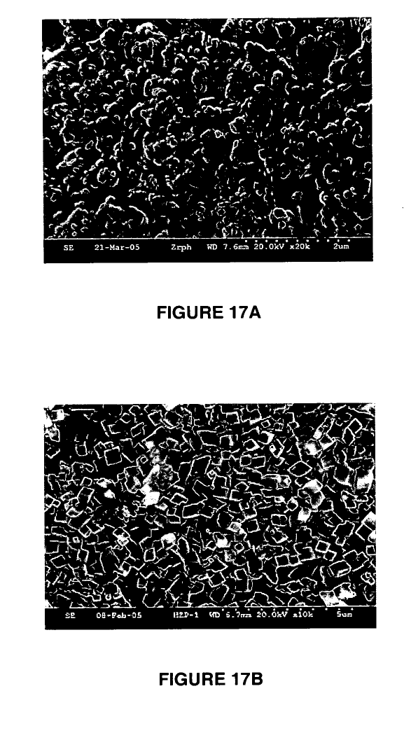

When the total percentage of the zirconium phosphate component is kept the same (10 mass %) for Nafion/α-ZPL and Nafion/ZPTD composite membranes, the SSA of α-ZPL is substantially higher, than that of ZPTD (SEM images, FIGS. 17A and 17B), suggesting a greater number of proton absorption sites per unit mass of α-ZPL and, as a result, an increase in the amount of interfacial water molecules and the PEM fuel cell performance. Moreover, the particles of α-ZPL and ZPTD exhibit distinct individual particle aggregation morphologies, as well as differing degrees of crystal face development, which may also be factors contributing to increased performance. In addition, the difference in the nature of the site in which a mobile proton is accommodated in each structure may affect the proton mobility and, consequently, the membrane performance. Descriptions and illustrations of the molecular structures of these compounds may be found in S. Yamanaka and M. Tanaka, J. Inorg. Nucl. Chem. 1979, 41, 45 and J. B. Goodenough, H. Y-P. Hong, and in J. A. Kafalas, Mat. Res. Bull. 1976, 11, 203. The performance improvement relating to the increased SSA of ZP is evident at reduced RH's where the initial water uptake of the membranes is small, and the fraction of water associated with the additional hydrophilic sites at the ZP surface is significantly higher than in the case of well-hydrated membranes.

In the case of the Nafion/ZP in situ composite membranes, the interface interaction between the polymer and dispersed ZP particles may be high due to the high SSA of the ZP nano-particles (˜10-12 nm, see P. Costamagna, C. Yang, A. B. Bocarsly, and S. Srinivasan, Electrochim Acta, 47, 1023, 2002.). This interaction enhances water retention capability of the membranes and their performance in PEMFCs. However, the Nafion/19% ZP in situ membrane demonstrates a lower performance than the Nafion/10% α-ZPL membrane, especially at 13% RH indicating that the layered crystalline ZP has better water retention properties than amorphous ZP incorporated by in situ precipitation.

Composite proton exchange membranes are described herein that are able to function at 120° C. under reduced RH conditions at the performance level comparable to that of regular Nafion at 80° C. High temperature microelectrophoresis measurements show that the rutile polymorph of TiO₂ has an isoelectric point (IEP) in the acid part of the pH scale (5.0-6.5) at ambient conditions, which decreases to around 4.2 as temperature increases to 200° C. A similar tendency is also established for the pH of zero proton charge (PZC) of the same TiO₂ powder using a high-temperature potentiometric titration technique (see M. L. Machesky, D. J. Wesolowski, D. A. Palmer, and M. K. Ridley, J. Colloid Interface Sci., 239, 314 (2001). While not wishing to be bound by theory, some consideration of theoretical aspects of inventive membrane function is included here. Thus, in aqueous solutions with pH's lower than the isoelectric point (IEP), rutile particle surfaces become positively charged due to surface protonation equilibria, as illustrated by the following reactions resulting from the Multisite Complexation (MUSIC) model for TiO₂ (rutile):
≡Ti—OH^{-0.31}+H⁺ [symbol] ≡Ti—OH₂^{+0.69} [1]
≡Ti₂—O^{-0.62}+H⁺ [symbol] ≡Ti₂—OH^{+0.38} [2]

As temperature increases, the equilibrium constants, K_{H1} and K_{H2}, shift towards lower values, which should result in even lower pH at the TiO₂/water interface. The thermodynamic equilibrium constants for these reactions are represented as a function of temperature by the following equations:
logK_{H1}=2699.5/T−25.28+9.27logT [3]
logK_{H2}=1917.3/T−17.94+6.58logT [4]

If the amount of liquid phase is relatively small compared to the solid phase (like in a dense slurry or in a membrane), reactions [1] and [2] act as pH buffers, producing mildly acidic solution, (see A. S. Arico, V. Baglio, A. Di Blasi, P. Creti, P. L. Antonucci, and V. Antonucci, Solid State Ionics, 161, 251 (2003). However, the buffering capacity of the EDL on the TiO₂ surface is low at small contents of TiO₂ in the membrane and would be likely exceeded by the intrinsic acidity of the membrane solution, which is due to the dissociation of sulfonic acid groups (see K. D. Kreurer, J. Membr. Sci., 185, 29 (2001):
—SO₃H═—SO₃⁻+H⁺ (log Kₐ=6 at 25° C.) [5]

Under fuel cell operation, protons are continuously generated at the anode side and driven through the membrane pore fluid, but the sulfonate groups remain largely unprotonated, even at pH's of 0-1. In the absence of essentially immobile counter-cations in the pore fluid, this would tend to retard the free diffusion of protons through the membrane, though the hydrophilic nature of the sulfonate groups would tend to attract water dipoles. Positively charged surfaces, such as that of rutile particles at low pH, may be able to counterbalance the negative charge of the sulfonate groups, such that the hydrophilic nature of the membrane may be further enhanced by the presence of both positively and negatively charged species fixed within the membrane. This may also permit the unhindered migration of protons through the membrane, since at least some sulfonate group charges may be counterbalanced by positively charged particle surfaces, rather than protons within the pore fluid. In other words, in the absence of fixed countercharges, the long range Coulombic attractive force of negatively-charged sulfonate groups may tend to retain protons within the membrane, even as they are ‘pushed’ through as a result of the external anode/cathode reactions. Disruption of the long-range coulombic attractive force for protons by the presence of fixed positively charged surfaces within the membrane may allow the protons to more readily pass through the membrane pore fluids unhindered.

At the acidic conditions in Nafion-based membranes, TiO₂ is characterized by relatively high positive surface charge density and zeta potential due to proton adsorption, see M. V. Fedkin, X. Y. Zhou, J. D. Kubicki, A. V. Bandura, S. N. Lvov, M. L. Machesky, and D. J. Wesolowski, Langmuir, 19, 3797 (2003). The high concentration of protons in the EDL is beneficial from the standpoint of the hydrophilicity of TiO₂-doped composite membranes, since the water species forming the EDL are retained at the TiO₂ surface by the electric field. Water retention properties of the TiO₂ powder are related to the particle morphology, particle size, aggregation, and porosity. Further, the intrinsic acid-base surface properties of the TiO₂ zeta potential and surface charge density, may play a primary part in the membrane conductivity and water balance.

### REFERENCES

1. W. G. Grot, G. Rajendran, Membranes containing inorganic fillers and membrane and electrode assemblies and electrochemical cells employing same, U.S. Pat. No. 5,919,583, (1999).
2. A. S. Arico, P. Creti, P. L. Antonucci, and V. Antonucci, Electrochem. Solid State Lett. 1, 66 (1998).
3. P. L. Antonucci, A. S. Arico, P. Creti, E. Rumunni, and V. Antonucci, Solid State Ionics, 125, 431 (1999).
4. C. Yang, S. Srinivasan, A. S. Arico, P. Creti, V. Baglio, and V. Antonucci, Electrochem. Solid-State Lett., 4, A31 (2001).
5. C. Trakanprapai, V. Esposito, S. Licoccia, E. Traversa, V. Baglio, A. Di Blasi, A. S. Arico, V. Antonucci, and P. L. Antonucci, in Proc. 204th Meeting of Electrochemical Society, Orlando, abs. 1080, The Electrochemical Society, Inc. (2003).
6. V. Baglio, A. Di Blasi, A. S. Arico, V. Antonucci, P. L. Antonucci, F. S. Fiory, S. Licoccia, and E. Traversa, in Proc. Mat. Res. Soc. Symp., 756, 345 Materials Research Society, Warrendale, Pa. (2003).
7. A. S. Arico, V. Baglio, A. Di Blasi, P. Creti, P. L. Antonucci, and V. Antonucci, Solid State Ionics, 161, 251 (2003).
8. P. Costamagna, C. Yang, A. B. Bocarsly, and S. Srinivasan, Electrochim Acta, 47, 1023 (2002).
9. K. T. Adjemian, S. J. Lee, S. Srinivasan, J. Benziger, and A. B. Bocarsy, J. Electrochem. Soc., 149, A256 (2002).
10. K. T. Adjemian, S. J. Lee, S. Srinivasan, J. Benziger, and A. B. Bocarsy, J. of Power Sources, 109, 356 (2002).
11. H. R. Kunz and J. M. Fenton, Meeting of Electrochem. Soc., Washington D.C., Mar. 29 (2001).
12. M. Watanabe, H. Uchida, Y. Seki, M. Emori, and P. Stonehart, J. Electrochem. Soc., 143, 3847 (1996).
13. M. Watanabe, H. Ushida, and M. Emori, J. Phys. Chem., B, 192, 3129 (1998).
14. H. Uchida, Y. Ueno, H. Hagihara, and M. Watanabe, J. Electrochem. Soc., 150, A256 (2003).
15. H. Uchida, Y. Mizuno, and M. Watanabe, J. Electrochem. Soc., 149, A682 (2002).
17. M. V. Fedkin, X. Y. Zhou, J. D. Kubicki, A. V. Bandura, S. N. Lvov, M. L. Machesky, and D. J. Wesolowski, Langmuir, 19, 3797 (2003).
18. X. Y. Zhou, X. J. Wei, M. V. Fedkin, K. H. Strass, and S. N. Lvov, Rev. Sci. Instrum., 74, 2501 (2003).
19. M. L. Machesky, D. J. Wesolowski, D. A. Palmer, and M. K. Ridley, J. Colloid Interface Sci., 239, 314 (2001).
20. K. D. Kreurer, J. Membr. Sci., 185, 29 (2001).
21. A. Ticianelli, C. R. Derouin, A. Redondo, and S. Srinivasan, J. Electrochem. Soc., 135, 2209 (1998).
22. A. L. Shao, K. A. Mauritz, and R. B. Moore, Chem Mater. 7, 192, (1995)
23. J. Larnie, A. Dicks, Fuel Cell Systems Explained, J. Wiley & Sons. Ltd., Artrium, Southern Gate, Chichester, West Sussex, England (2003).
24. Q. F. Li, R. H. He, J. O. Jensen, and N. J. Bjerrum, Chem. Mater., 15, 4896 (2003).
25. G. Alberti, M. Casciola, Annu Rev. Mater. Res., 33, 129 (2003).
26. E. Chalkova, M. B. Pague, M. V. Fedkin, D. J. Wesolowski, and S. N. Lvov, J. Electrochem. Soc. 152, (6), 2005,
27. Y. Si, H. R. Kunz, and J. M. Fenton, J. Electrochem. Soc., 151, 4, A263 (2004).
28. M. L. Machesky, D. J. Wesolowski, D. A. Palmer, K. Ichiro-Hayashi, J. Colloid Interface Sci. 200, 298 (1998).
29. P. Colomban (Ed.), Proton Conductors: Solids, Membranes and Gels—Materials and Devices, Cambridge University Press, 1992.
30. P. Costamagna, C. Yang, A. B. Bocarsly, and S. Srinivasan, Electrochim Acta, 47, 1023, 2002.
31. J. B. Goodenough, H. Y-P. Hong, and J. A. Kafalas, Mat. Res. Bull. 1976, 11, 203.
32. A. Clearfield, B. D. Roberts, and M. A. Subramanian, Mar. Res. Bull., 1984, 19, 219.
33. S. Komarneni, Q. H. Li, and R. Roy, J. Mat. Chem. 1994, 4, 1903.
34. S. Yamanaka and M. Tanaka, J. Inorg. Nucl. Chem. 1979, 41, 45.

Embodiments of inventive membranes and apparatus are illustrated in the following examples. These examples are provided for illustrative purposes and are not considered limitations on the scope of inventive membranes and apparatus.

### EXAMPLES

### Example 1

One TiO₂ powder used is pure crystalline rutile (α-TiO₂) obtained from Kronos, Inc. (Kronos 4020). The powder is sorted, cleaned, and characterized at the Oak Ridge National Laboratory as described in detail in M. V. Fedkin, X. Y. Zhou, J. D. Kubicki, A. V. Bandura, S. N. Lvov, M. L. Machesky, and D. J. Wesolowski, Langmuir, 19, 3797 (2003). The resulting TiO₂ material contains no detectable crystalline contaminants and mainly consists of 3-50 μm aggregates of anhedral or subhedral 0.1-1.0 μm rutile grains. The specific surface area of the powder is determined by BET multipoint N₂ surface area analysis as 2.914±0.004 m²·g⁻¹. (see M. V. Fedkin, X. Y. Zhou, J. D. Kubicki, A. V. Bandura, S. N. Lvov, M. L. Machesky, and D. J. Wesolowski, Langmuir, 19, 3797 (2003).

### Example 2

Composite Nafion/TiO₂ membranes are prepared using a recast procedure for the preparation of composite Nafion/SiO₂ membranes. Appropriate amounts of commercial 5% Nafion solution (Aldrich) and TiO₂ powder are mixed and sonicated in an ultrasonic bath. The suspension is cast and heated at 80° C. until dry. The recast composite films are then hot-pressed at a low pressure (less than 2 bars) at 150° C. for 10 minutes. The thickness of the membranes is about 80 microns. The membranes are purified using a standard procedure described in A. Ticianelli, C. R. Derouin, A. Redondo, and S. Srinivasan, J. Electrochem. Soc., 135, 2209 (1998). Nafion-based composite membranes, containing 0, 10, and 20 mass % TiO2, are prepared.

### Example 3

Membrane-electrode assemblies (MEAs) are prepared using a commercial gas diffusion solid polymer electrolyte electrode of Los Alamos type (ELAT) with double sided coatings. Electrode specifications are as follows: Pt loading 0.5 mg×cm-2 with 20% Pt on Vulcan XC-72 as a catalyst, Nafion loading 0.8 mg×cm-2, and standard PTFE loading. MEAs are prepared by pressing the electrodes onto the membrane in a Carver hot press at 130° C. and 50 bar for 40 seconds.

### Example 4

MEAs are coupled with Teflon gas-sealing gaskets and placed in a 5 cm² ElectroChem fuel cell, which is capable of operating at temperatures up to 130° C. and at pressures up to 3.5 bar. The voltage and current of the fuel cell are measured simultaneously using an electronic load (Hewlett Packard Co.) and electrometer (Keithley Instruments, Inc.). The high temperature fuel cell operating system is equipped for monitoring the temperature, gas flow rate, and pressure. Water traps are installed in front of back pressure regulators in the oxygen and hydrogen lines to prevent valve clogging at a high relative humidity (RH). To ensure data consistency, each fuel cell arrangement (compaction force) and operating conditions (hydrogen and oxygen pressures, temperature, and RH) are the same for the tests of membranes with different compositions.

Prior to the high temperature performance tests, the membranes are hydrated at ambient temperature using the water produced in the fuel cell under an external load of 0.01 Ω. This procedure is used to re-hydrate the membranes after hot-pressing. During the high temperature PEMFC performance tests, the cell is fed with humidified reactant gases of high purity. Humidification of both H₂ and O₂ was temperature-controlled. Fuel cell tests are performed at 80 and 120° C., at 26, 50, 80, and 100% RH with the total pressure (reactant gas and water vapor) of 3 bar. Membranes with different TiO2 contents (0, 10, and 20 mass %) are tested using an identical procedure. All the experimental results are obtained under steady-state conditions, i.e., current density remained constant in time at a fixed cell voltage.

### Example 5

TiO₂ Powder Characterization

Two TiO₂ powders are used for composite membrane fabrication. Both powders are prepared at Oak Ridge National Laboratory, where they are pretreated by refluxing in deionized water many times at 100° C., followed by repeated rinsing/settling/decanting cycles in deionized water and finally, hydrothermal reaction at 220° C. for several days in a Teflon-lined pressure vessel containing the powder suspended in excess deionized water, as described in M. V. Fedkin, X. Y. Zhou, J. D. Kubicki, A. V. Bandura, S. N. Lvov, M. L. Machesky, and D. J. Wesolowski, Langmuir, 19, 3797 (2003); and M. L. Machesky, D. J. Wesolowski, D. A. Palmer, K. Ichiro-Hayashi, J. Colloid Interface Sci. 200, 298 (1998). Prior to use in membrane fabrication, the powders are characterized using a number of analytical methods, and respective properties and specifications are listed in Table 1.

### Example 6

Composite Nafion/TiO₂ membranes are prepared using TiO₂-I and TiO₂-II described in Example 5 using a recasting procedure and a purification procedure as described in Example 2. The membrane thickness is around 80 microns. The membranes are prepared containing 10% by weight of either TiO₂-I or TiO₂-II.

### Example 7

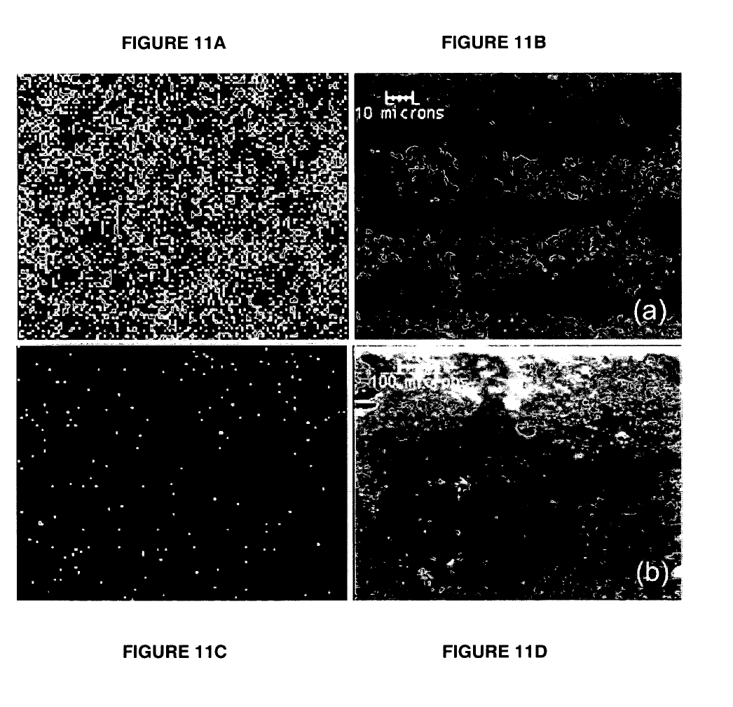

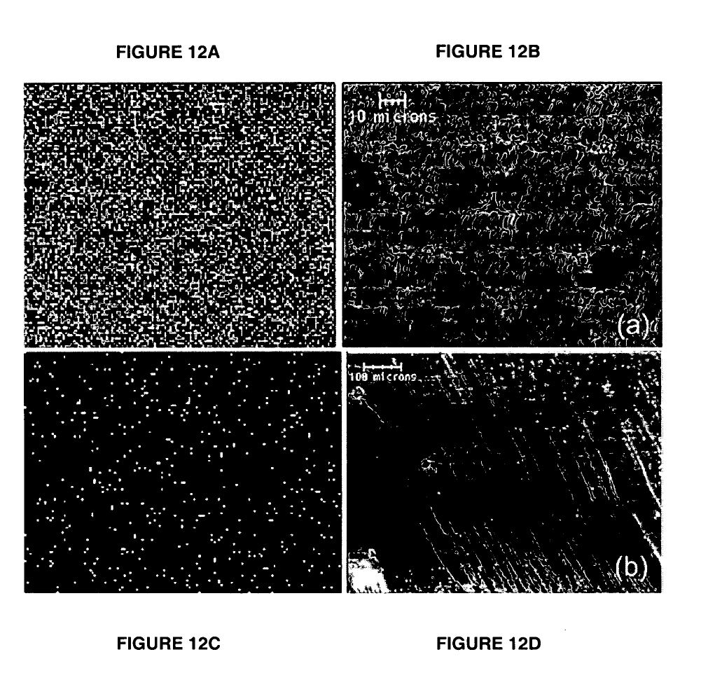

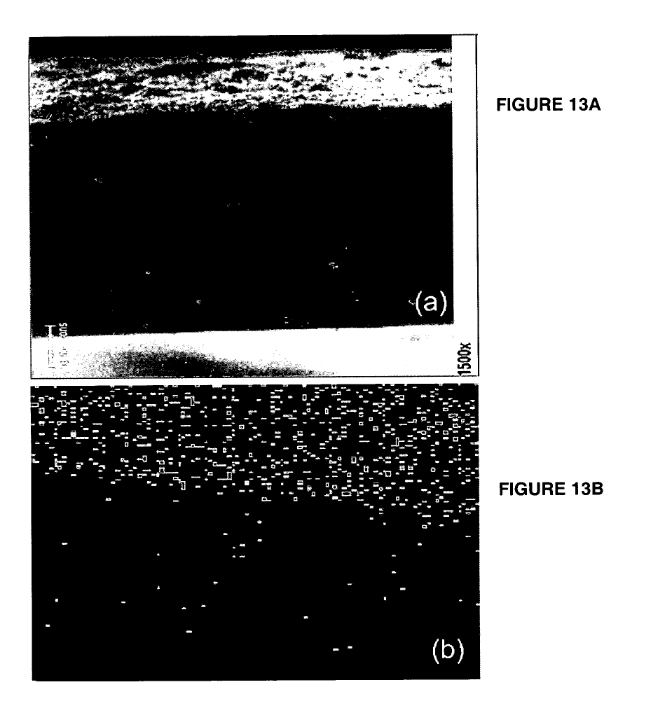

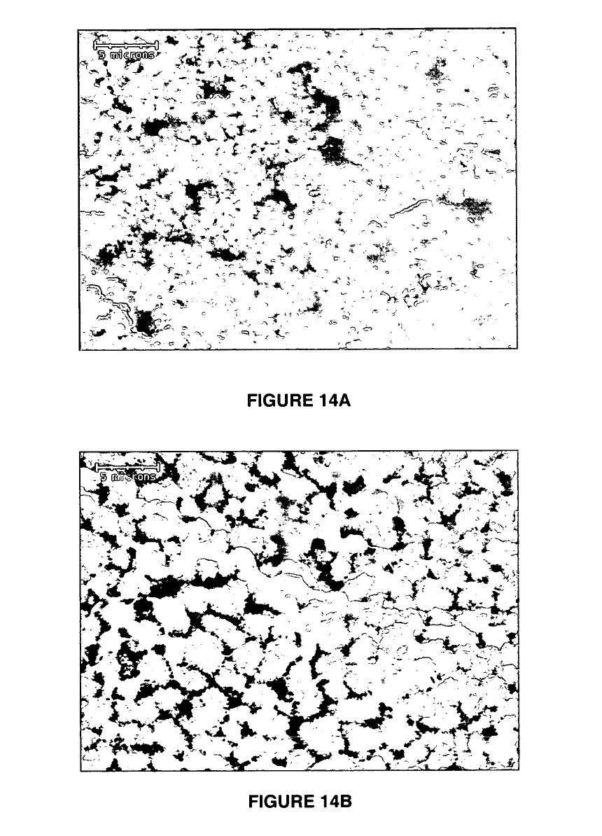

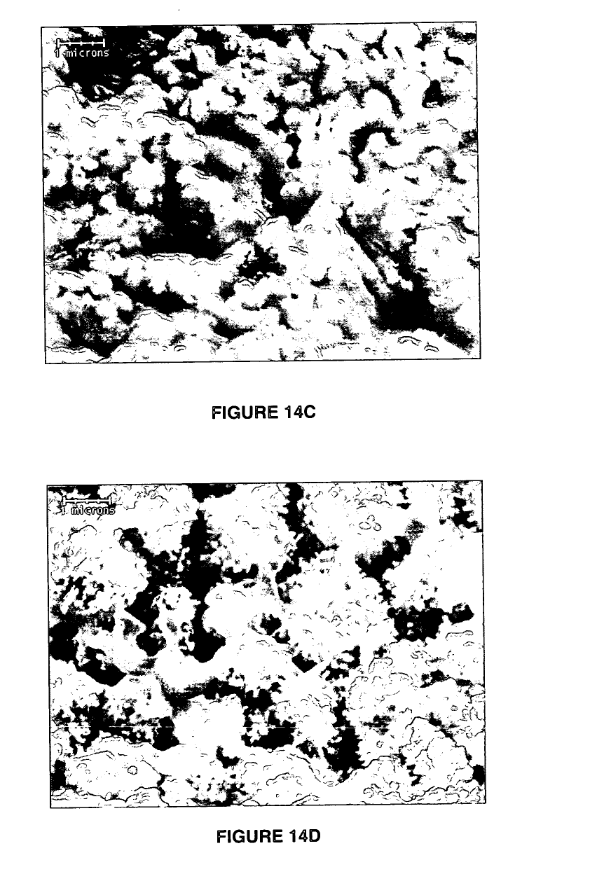

Membranes prepared according to Example 6 are analyzed and it is found that unlike regular transparent Nafion, the composite membranes are opaque white due to inclusion of TiO₂ particles. The bottom side of each membrane had a dull surface, while the top side had a shiny appearance. Scanning electron microscope (SEM), JEOL JSM5400, and Electron dispersive spectroscope (EDS), PGT IMIX-PC, are used to analyze the presence and distribution of TiO2 particles on both sides and over the cross section of the membranes. The dull sides of the Nafion/10% TiO₂ composite membranes prepared with both TiO₂-I and TiO₂-II powders are completely covered by TiO₂ agglomerates (FIGS. 11A, 11B, 12A and 12B), while the shiny sides are dominated by the polymer matrix with scarce dissemination of isolated TiO2 particles (FIGS. 11C,11D, 12C and 12D). The SEM-EDS analysis performed for the cross section of the Nafion/TiO₂-II membrane shows a significant gradient of TiO₂ content across the membrane (FIGS. 13A and 13B). The TiO₂ component is concentrated near the bottom surface of the membrane, and the thickness of the TiO₂-rich layer is about 15% of the total membrane thickness. This two-layer membrane structure may be formed as a result of slow settling of TiO₂ particles in the Nafion solution during the 2.5-hour casting procedure. The morphology of TiO₂ agglomerates and the polymer in both types of composite membranes is shown in FIGS. 14A, 14B, 14C and 14D. As can be seen from these SEM images, both, the TiO₂-I and TiO₂-II particles at the dull side of the membranes form agglomerates. Some groups of the agglomerates appear to be coated by the polymer, which fills interstices between the grains. The TiO₂-I particles of typical size of 0.5-1 mm with a smooth surface look dense. They form a continuous, porous agglomerate at the dull side of the membrane (FIG. 14A,C). The TiO₂-II particles look porous. They form porous agglomerates of typical size of 1-3 microns, which are more regular in shape (close to spherical) compared to TiO₂-I (FIG. 14B,D). These agglomerates include smaller particles, 200-300 nm in size, and the porous texture of these agglomerates provides a high surface area for water retention. The observed texture of both types of membranes suggests that overall porosity of the membranes may increase due to incorporation of the TiO₂ powder. These pores inside the membranes may contain bulk water under fuel cell operating conditions.

### Example 8

Fuel Cell Tests of Membranes Prepared According to Example 6.

Membrane-electrode assemblies (MEAs) are prepared using the procedure described in Example 3 and in E. Chalkova, M. B. Pague, M. V. Fedkin, D. J. Wesolowski, and S. N. Lvov, J. Electrochem. Soc. 152, (6) 2005, The fabricated MEAs are matched with Teflon gas-sealing gaskets and placed in a 5-cm² ElectroChem fuel cell. The high temperature fuel cell operating system is described in Chalkova et al, idem. and Example 4. During the high temperature PEM fuel cell performance tests, humidified hydrogen and oxygen of high purity are fed to the fuel cell. Humidification of both reactant gases is temperature-controlled. The fuel cell tests are performed on recast Nafion, Nafion/10% TiO₂-I, and Nafion/10% TiO₂-II membranes at 80 and 120° C., at 26, and 50% RH with the total pressure (reactant gas and water vapor) of 3 bar. The experimental polarization curves for Nafion and both types of composite membranes obtained at 80 and 120° C. are shown in FIGS. 15 and 16, respectively. The current density is calculated considering the surface area of the gas flow channels. All the experimental results are obtained under steady-state conditions (i.e., current density remained constant in time at a fixed cell voltage).

### Example 9

Zirconium Phosphate Powders

Two types of proton-conducting zirconium phosphate materials are synthesized for use in composite membranes: layer-structured phases α-zirconium hydrogen phosphate, α-Zr(HPO₄)2.H₂O (α-ZPL) and three-dimensional network phases zirconium hydrogen phosphate, H₃OZr₂(PO₄)₃ (ZPTD). Descriptions and illustrations of the molecular structures of these compounds may be found in S. Yamanaka and M. Tanaka, J. Inorg. Nucl. Chem. 1979, 41, 45 and J. B. Goodenough, H. Y-P. Hong, and in J. A. Kafalas, Mat. Res. Bull. 1976, 11, 203.

In layer-structured hydrogen phosphates, the protons are in the interlayers being attached to the PO₄ tetrahedrons and surrounded by water molecules. These layered phases have extremely high proton contents (˜7 meq/g), see P. Colomban (Ed.), Proton Conductors: Solids, Membranes and Gels—Materials and Devices, Cambridge University Press, 1992. The compound is hydrated; most of the conductivity is a result of proton migrating over the surface of individual crystallites. It has a high proton conductivity of 10⁻⁴ S/cm at 100° C., see P. Costamagna, C. Yang, A. B. Bocarsly, and S. Srinivasan, Electrochim Acta, 47, 1023, 2002.

In three-dimensional network hydrogen phosphates, protons occupy the positions of Na cations in the so-called “NZP” structure, see J. B. Goodenough, H. Y-P. Hong, and J. A. Kafalas, Mat. Res. Bull. 1976, 11, 203. These compounds retain water up to 300° C. because of very small pore size and extreme hydrophilicity, see A. Clearfield, B. D. Roberts, and M. A. Subramanian, Mar. Res. Bull., 1984, 19, 219; and show proton conductivities of about 10⁻⁶ S cm⁻¹, see Colomban, Id.

Both powders are synthesized at the PSU Material Research Laboratory using either conventional- or microwave-hydrothermal processing, see Colomban, Id., and S. Komarneni, Q. H. Li, and R. Roy, J. Mat. Chem. 1994, 4, 1903.

The α-zirconium phosphate is synthesized as follows: (1) a stoichiometric mixture is formed by titrating 1M Zr oxychloride into a Na₂HPO₄ solution while stirring; then pH is adjusted to below 0.5, and this mixture is treated in microwave hydrothermal vessels at 200° C. for crystallization of α-zirconium phosphate. A zeta potential of −30 mV is measured at pH 2.5, 25° C.

The three-dimensional phase is synthesized as follows: NH₄Zr₂(PO₄)₃ is synthesized using 1M Zr oxychloride and 1M (NH₄)H₂PO₄ under conventional hydrothermal conditions; then it is fired in air at 500° C. to remove ammonia and to obtain HZr₂(PO₄)₃. See A. Clearfield, B. D. Roberts, and M. A. Subramanian, Mar. Res. Bull., 1984, 19, 219. The HZr₂(PO₄)₃ is treated hydro-thermally to obtain HZr₂(PO₄)₃ with water molecules. A zeta potential of +30 mV is measured at pH 2.5, 25° C.

### Example 10

Scanning electron microscopy is performed on materials synthesized as described in Example 9. Scanning electron microscopy (SEM) images show that the powders have different morphology and particle size and shape. (FIGS. 17A and 17B) The α-ZPL (FIG. 17A) is represented by smaller particles (60-200 nm) than ZPTD (300-700 nm) (FIG. 17B). These particles have anhedral grains and form porous aggregates 600-800 nm in size. The ZPTD particles look like rhombohedra. They are quite uniform in size, without evidence of aggregation. The α-ZPL structure provides a higher specific surface area (SSA) than the ZPTD structure.

### Example 11

Composite Nafion/α-ZPL and Nafion/ZPTD membranes are prepared using a recast procedure as described in Example 2.

### Example 12

A composite Nafion/ZP membrane is prepared using an in situ procedure as described in W. G. Grot and G. Rajendran, U.S. Pat. No. 5,919,583, 1999; and in C. Yang, S. Srinivasan, A. B. Bocarsly, S. Tulyani, J. B. Benziger, J. Membr. Sci., 237, 145, 2004.

Briefly, a Nafion membrane is cast following the procedure in Example 2. The membrane is then swelled in a boiling methanol-water solution to facilitate ionic diffusion and dipped into a 1M solution of zirconyl chloride (ZrOCl₂) for six hours at 80° C. During this time Zr⁴⁺ ions exchange with sulfonic acid protons in the membrane. The membrane is rinsed thoroughly and placed in 1M phosphoric acid (H₃PO₄) solution for six hours at 80° C. to precipitate insoluble ZP in situ and to protonate sulfonate anions to regenerate the membrane's acidity. The thickness of the fabricated membranes is about 80 microns.

### Example 13

Fuel Cell Tests

Membrane-electrode assemblies (MEAs) are prepared using a standard commercial gas diffusion solid polymer electrolyte electrode of Los Alamos type (ELAT) with double sided coatings. MEAs are prepared using a hot press technique (130° C., 50 bar). The fabricated MEAs are coupled with Teflon gas-sealing gaskets and placed in a 5 cm² ElectroChem fuel cell. The performance of the H₂/O₂ PEMFCs employing Nafion/ZP composite membranes of different types is evaluated as described for Nafion/TiO₂ composite membranes. The fuel cell tests are performed at 80 and 120° C., at 13, 26, and 50% RH with the total pressure (reactant gas and water vapor) of 2 bar. All the experimental results are obtained under steady-state conditions (i.e., current density remained constant in time at a fixed cell voltage). The current density is calculated considering the surface area of the gas flow channels.

Any patents or publications mentioned in this specification are herein incorporated by reference to the same extent as if each individual publication was specifically and individually indicated to be incorporated by reference. In particular, U.S. Provisional Patent Application Ser. No. 60/561,356 filed Apr. 12, 2004, is incorporated herein by reference in its entirety.

The compositions, apparatus and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

1. A proton exchange membrane, comprising:
a proton exchange polymer having proton exchange groups thereon, the polymer containing a plurality of agglomerates of metal oxide or metal phosphate particles, the plurality of agglomerates characterized in that the agglomerates have a size in the range of 100 nanometers to 50 microns along a largest dimension.

2. The proton exchange membrane of claim 1 wherein the plurality of agglomerates are interconnected to form a porous network of agglomerates.

3. The proton exchange membrane of claim 1 wherein the particle comprising a metal oxide or metal phosphate has an isoelectric point in the range of pH 0-7 at 25° C.

4. The proton exchange membrane of claim 1 wherein the metal oxide is selected from the group consisting of: a group IVa metal oxide and a group IVb metal oxide.

5. The proton exchange membrane of claim 4 wherein the metal oxide is selected from the group consisting of: SiO₂, ZrO₂, GeO₂ and SnO₂.

6. The proton exchange membrane of claim 1 wherein the metal oxide is titanium dioxide.

7. The proton exchange membrane of claim 1 wherein the metal phosphate is a zirconium phosphate.

8. The proton exchange membrane of claim 1 wherein the particles have a size along a largest dimension in the range between 10 nanometers-1 micron, inclusive.

9. The proton exchange membrane of claim 1 wherein the particles have a zeta potential in the range of −100-+100 millivolts at pH 2.5 and at 25° C.

10. The proton exchange membrane of claim 1 wherein the particles have a zeta potential in the range of 15-55 millivolts at pH 2.5 and at 25° C.

11. The proton exchange membrane of claim 1 wherein the particles have a zeta potential in the range of −40-−20 millivolts at pH 2.5 and at 25° C.

12. The proton exchange membrane of claim 1 wherein the agglomerates have a size in the range of 500 nanometers to 10 microns along a largest dimension.

13. The proton exchange membrane of claim 1 wherein the proton exchange polymer having proton exchange groups thereon is a perfluorinated alkene having proton exchange groups thereon.

14. The proton exchange membrane of claim 1 wherein the proton exchange groups are selected from the group consisting of: sulfonate and carboxylate.

15. The proton exchange membrane of claim 1 wherein the particles have a specific surface area in the range between 1-100 m²/g, inclusive.

16. A proton exchange membrane having a first surface and a second surface, the second surface opposing the first surface, the membrane having a thickness extending between the first and second surfaces, comprising:
a proton exchange polymer enriched portion having a length and a width defining the first surface, the polymer portion extending toward the second surface; and
an agglomerate enriched portion comprising a plurality of agglomerates of group IV metal oxide or phosphate particles, the agglomerate portion having a length and a width defining a second surface, the agglomerate enriched portion extending toward and in contact with the polymer enriched portion.

17. The proton exchange membrane of claim 16 wherein the agglomerate enriched portion comprises a percentage of agglomerates greater than 50% of the total agglomerates in the membrane.

18. The proton exchange membrane of claim 16 wherein the agglomerate enriched portion comprises 75-100% of the total agglomerates in the membrane.

19. The proton exchange membrane of claim 16 wherein the plurality of agglomerates is interconnected to form a porous network of agglomerates.

20. The proton exchange membrane of claim 16 wherein the group IV metal oxide or phosphate particles have an isoelectric point in the range of 0-7 at 25° C.

21. The proton exchange membrane of claim 16 wherein the particles have a zeta potential in the range of −100-+100 millivolts at pH 2.5 and at 25° C.

22. The proton exchange membrane of claim 16 wherein the particles have a specific surface area in the range between 1-100 m²/g, inclusive.

23. The proton exchange membrane of claim 16 wherein the polymer enriched portion has a thickness greater than the thickness of the agglomerate enriched portion.

24. The proton exchange membrane of claim 16 wherein the thickness of the membrane is in the range of 10-300 microns.

25. A proton exchange membrane having a first surface and a second surface, the second surface opposing the first surface, the membrane having a thickness extending between the first and second surfaces, comprising:
a proton exchange polymer having proton exchange groups thereon, the polymer containing an inorganic material localized at the first or second surface of the membrane such that a percentage of the thickness of the membrane ranging between 0.01-50% is enriched in the inorganic material.

26. A proton exchange membrane comprising:
a proton exchange polymer; and
a plurality of zirconium phosphate particles.

27. The proton exchange membrane of claim 26 wherein the plurality of zirconium phosphate particles have the molecular formula: α-Zr(HPO₄)₂.H2O particle.

28. The proton exchange membrane of claim 26 wherein the zirconium phosphate particles have the molecular formula: H₃OZr₂(PO₄)₃.

29. The proton exchange membrane of claim 26 wherein the zirconium phosphate particles have a specific surface area in the range between 1-200 m²/g, inclusive.

30. The proton exchange membrane of claim 26 wherein the particles have a size along a largest dimension in the range between 10 nanometers-1 micron, inclusive.

31. The proton exchange membrane of claim 26 wherein the particles have a size along a largest dimension in the range between 15 nanometers-250 nanometers, inclusive.

32. The proton exchange membrane of claim 26 wherein the particles have a size along a largest dimension in the range between 300 nanometers-800 nanometers, inclusive.

33. The proton exchange membrane of claim 26 wherein the plurality of particles is associated as a plurality of particle agglomerates.

34. The proton exchange membrane of claim 33 wherein the plurality of particle agglomerates is interconnected to form a porous network of agglomerates.

35. The proton exchange membrane of claim 26 wherein the plurality of particles has a zeta potential in the range of −100-+100 millivolts at pH 2.5 and at 25° C.
